(19) United States
(12) Patent Application Publication
(10) Pub. No.: US 2025/0254690 A1
(43) Pub. Date: Aug. 7, 2025

(54) RESOURCE ALLOCATION FOR MULTI-PANEL SIMULTANEOUS PUSCH TRANSMISSION

(71) Applicant: APPLE INC., CUPERTINO, CA (US)

(72) Inventors: Seyed Ali Akbar FAKOORIAN, SAN DIEGO, CA (US); Haitong SUN, SARATOGA, CA (US); Yushu ZHANG, BEIJING (CN); Weidong YANG, SAN DIEGO, CA (US)

(21) Appl. No.: 18/857,468

(22) PCT Filed: Apr. 29, 2022
(86) PCT No.: PCT/CN2022/090536

§ 371 Date: Oct. 17, 2024

(30) Foreign Application Priority Data
Apr. 29, 2022 (WO) PCT/CN2022/090536

(51) Int. Cl. H04W 72/21; H04B 7/06; H04W 72/044

(52) U.S. Cl. CPC H04W 72/21; H04B 7/06952; H04W 72/044

(57) ABSTRACT

Methods and apparatuses for using a single downlink control information (DCI) and supporting simultaneous transmission simultaneous Physical Uplink Shared Channels (PUSCHs) using multiple user equipment (UE) antenna panels are described. In some embodiments, a baseband processor is configured to perform operations comprising: receiving an RRC configuration information from a base station, wherein the RRC configuration information comprises an uplink transmission scheme using multiple antenna panels for transmitting multiple PUSCHs simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability; receiving a single downlink control information (DCI) that specifies an uplink resource allocation for a plurality of Physical Uplink Shared Channels (PUSCHs); and transmitting the plurality of PUSCHs.

### FIELD OF INVENTION

This invention relates generally to wireless technology and more particularly to performing resource allocation for a multi-panel simultaneous transmission of multiple Physical Uplink Shared Channels (PUSCHs).

### BACKGROUND

Fifth generation mobile network (5G) is a wireless standard that aims to improve upon data transmission speed, reliability, availability, and more. This standard, while still developing, includes numerous details relating to various aspects of wireless communication, for example, NR and NR in a spectrum greater than 52.6 GHz.

### SUMMARY OF THE DESCRIPTION

Methods and apparatuses for using a single downlink control information (DCI) and supporting simultaneous transmission simultaneous Physical Uplink Shared Channels (PUSCHs) using multiple user equipment (UE) antenna panels are described. In some embodiments, a baseband processor is configured to perform operations comprising: receiving an RRC configuration information from a base station, wherein the RRC configuration information comprises an uplink transmission scheme using multiple antenna panels for transmitting multiple PUSCHs simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability; receiving a single downlink control information (DCI) that specifies an uplink resource allocation for a plurality of Physical Uplink Shared Channels (PUSCHs); and transmitting the plurality of PUSCHs.

In some embodiments, a base station comprising a processor (or processing circuitry) configured to perform operations comprising: sending an RRC configuration information, wherein the RRC configuration information comprises uplink transmission scheme using multiple antenna panels for transmitting multiple PUSCHs simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability; generating a single downlink control information (DCI) that specifies an uplink resource allocation for a plurality of Physical Uplink Shared Channels (PUSCHs); and transmitting the single DCI to the UE.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to some embodiments.

FIG. 2 illustrates a base station (BS) in communication with a user equipment (UE) device according to some embodiments.

FIG. 3 illustrates an example block diagram of a UE according to some embodiments.

FIG. 4 illustrates an example block diagram of a BS according to some embodiments.

FIG. 5 illustrates an example block diagram of cellular communication circuitry, according to some embodiments.

FIG. 6A illustrates a data flow diagram of some embodiments of single downlink control information (DCI) resource allocation to support multi-panel simultaneous transmission of multiple Physical Uplink Shared Channels (PUSCHs) by a UE.

FIG. 6B illustrates examples of PUSCHs with a full overlap in frequency resources allocated to the PUSCHs that are to be simultaneously transmitted, no overlap in frequency resources allocated to the PUSCHs that are to be simultaneously transmitted and a partial overlap in frequency resources allocated to the PUSCHs that are to be simultaneously transmitted.

FIGS. 7A and 7B illustrate examples of the PUSCHs for a first transmission scheme.

FIGS. 8A and 8B illustrate examples of a second transmission scheme.

FIGS. 9A and 9B illustrate examples of a third transmission scheme.

FIG. 10A illustrates an example of a mapping scheme for a third transmission scheme,

FIGS. 11A and 11B illustrate an example of PUSCH mapping for each repetition when transmitting two PUSCH transmissions (e.g., PUSCH1 and PUSCH2) of the same TB over multi-panel simultaneously.

FIGS. 12A and 12B illustrate an example of PUSCH mapping for each repetition when transmitting two PUSCH transmission chains for two PUSCHs (e.g., PUSCH1 and PUSCH2) of the same TB over multiple UE antenna panels simultaneously.

FIG. 13 illustrates an example of frequency hopping for a multi-panel simultaneous transmission involving the transmission of a single TB with repetition.

FIG. 14 is a flow diagram of some embodiments of a process for configuring a UE.

FIG. 15 is a flow diagram of some embodiments of a process by which network equipment configures a UE.

### DETAILED DESCRIPTION

A method and apparatus of a device that performs resource allocation for a multi-panel simultaneous transmission of multiple Physical Uplink Shared Channels (PUSCHs) using a single downlink control information (DCI) is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that performs resource allocation for a multi-panel simultaneous transmission of multiple Physical Uplink Shared Channels (PUSCHs) using a single downlink control information (DCI) is described. In one embodiment, the device is a user equipment device that has a wireless link with a base station. In one embodiment, the wireless link is a fifth generation (5G) link.

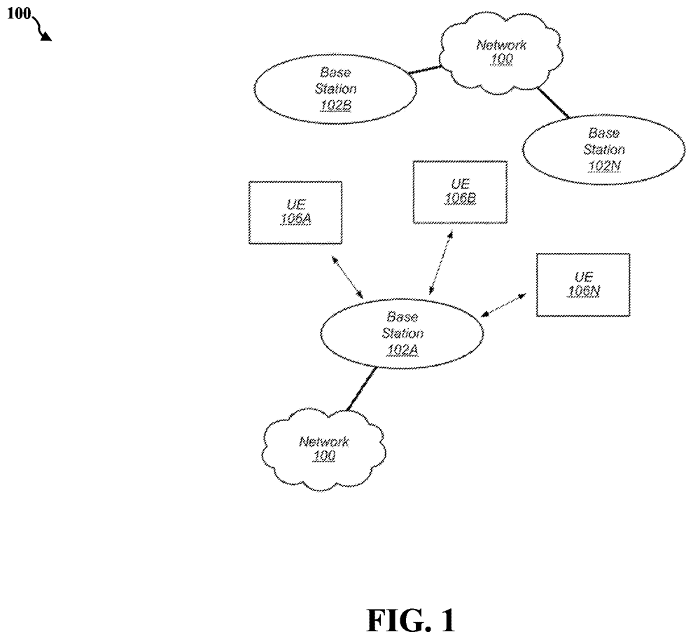

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

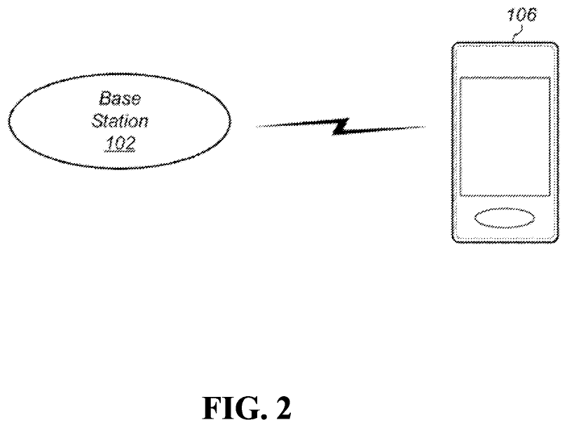

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

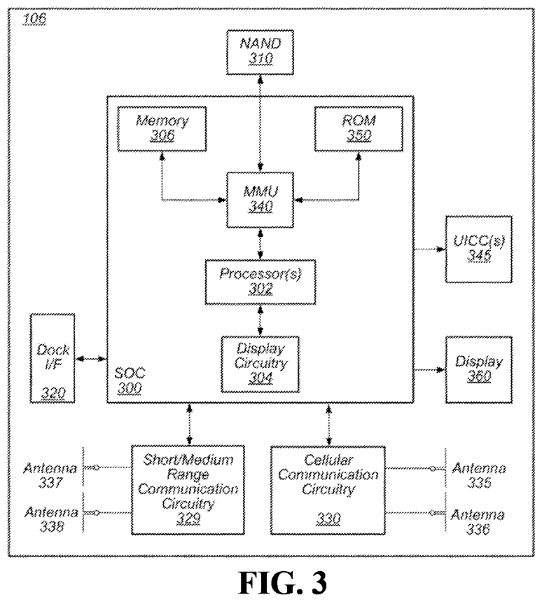

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to receive configuration information from a base station, where the configuration information comprises a single downlink control information (DCI) that specifies an uplink resource allocation for a plurality of Physical Uplink Shared Channels (PUSCHs) and the uplink resource allocation for the plurality of PUSCHs is specified, per user equipment (UE) antenna panel. The wireless device may also be configured transmit information on the plurality of PUSCHs simultaneously via the plurality of antenna panels based on the configuration information in the single DCI, with one PUSCH of the plurality of PUSCHs being transmitted on a different one of the plurality of PUSCHs.

As described herein, the communication device 106 may include hardware and software components for implementing the above features for time division multiplexing UL data for NSA NR operations. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

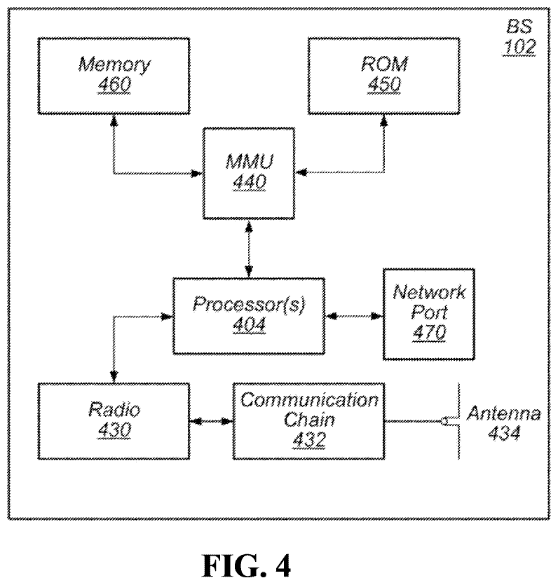

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

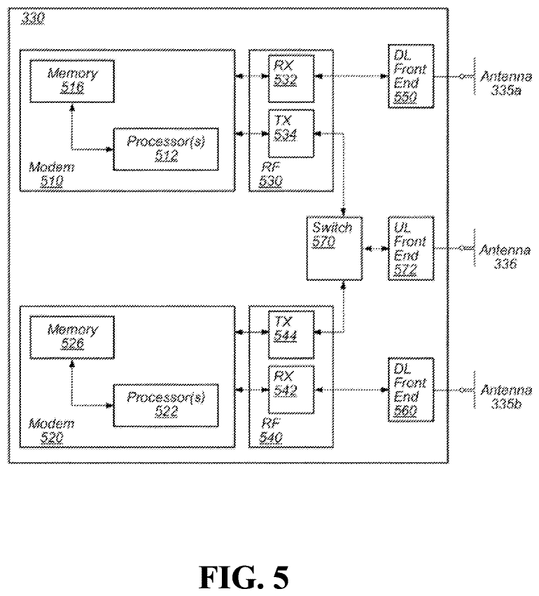

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be include in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown (in FIG. 3). In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for performing resource allocation for a multi-panel simultaneous transmission of multiple PUSCHs using a single DCI, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for performing resource allocation for a multi-panel simultaneous transmission of multiple PUSCHs using a single DCI, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated

Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

### Single DCI and the Indication of Multi-Panel Simultaneous Transmissions of PUSCHs

In some embodiments, the techniques described herein are for performing resource allocation to signal resources to a UE to enable the UE to simultaneously transmit multiple PUSCHs using multiple antenna panels of the UE. In some embodiments, the resource allocation is performed by a base station (e.g., gNB) using a single DCI.

In NR Release 16, the NR Standard specifies simultaneous Physical Downlink Shared Channel (PDSCH) reception(s) for multi-Transmission and Reception Point (TRP). In this case, if scheduled by a single DCI, PDSCH resources associated to different downlink (DL) beams (spatial Rx filters) are sent via frequency division multiplexing (FDM). As set forth in 3GPP TS 38.214, Sec. 5.1, the UE is indicated with two Transmission Configuration Indication (TCI) states in a codepoint of the DCI field ‘Transmission Configuration Indication’ and demodulation reference signal (DM-RS) port(s) within one code division multiplexing (CDM) group in the DCI field ‘Antenna Port(s)’. When the UE is set to ‘fdmSchemeA’, the UE shall receive a single PDSCH transmission occasion of the Transport Block (TB) with each TCI state associated with a non-overlapping frequency domain resource allocation. When the UE is set to ‘fdmSchemeB’, the UE shall receive two PDSCH transmission occasions of the same TB with each TCI state associated to a PDSCH transmission occasion which has a non-overlapping frequency domain resource allocation. If scheduled using multiple DCIs, referred to as multi-DCI (m-DCI), two PDSCH receptions can be fully/partially/non-overlapped PDSCHs in time and frequency domain. In this case, the PDCCHs that schedule two PDSCHs are associated with different ControlResourceSets having different values of coresetPoolIndex.

In NR Release 17, the UE can transmit multiple repetitions of the same TB across different uplink (UL) beams, where repetitions are transmitted using time division multiplexing (TDM). That is, there is beam hopping but that beam hopping is for TDM. In order to transmit the multiple repetitions of the same TB across different UL beams, the beam indication is provided by extending a Status-Report-Indication (SRI) bit field (done by UE), when the UE is configured for two Sounding Reference signal (SRS) resource sets with usage as codebook (or two SRS resource sets with usage as non-codebook). Also, when transmitting multiple repetitions across different UL beams, all repetitions have the same rank (number of layers), although repetitions over different beams may have different antenna ports, Transmitted Precoding Matrix Indicator (TPMI) (for code block (CB) based transmission), Transmit Power Control (TPC), etc. In other words, the repetition doesn't happen in time; it occurs in different time slots.

In NR Release 16 and Release 17, simultaneous PUSCH transmission is not supported (not for spatial division multiplexing (SDM) nor frequency division multiplexing (FDM).

In NR Release 18, one of the objectives is to study and if needed specify the simultaneous multi-panel UL transmission, including providing an UL precoding indication for PUSCH, considering the use of single DCI and multi-DCI based multi-TRP operation and providing an UL beam indication for PUCCH/PUSCH, considering the use of a single DCI and multi-DCI based multi-TRP operation.

In some embodiments, the UE is configured to perform the transmission of multiple PUSCHs simultaneously using multiple antenna panels on the UE. This is referred to herein as Multi-Panel Simultaneous PUSCHs. In some embodiments, the multiple PUSCH transmissions include two PUSCH transmissions, one PUSCH from one antenna on the UE and another PUSCH from another antenna on the UE, where both UE antennas are part of a multi-panel antenna. The configuration information for configuring the UE to perform the multi-panel simultaneous transmission of multiple PUSCHs is sent from a base station.

In some embodiments, information is sent from the base station to the UE using a single DCI (s-DCI) that specifies the transmission scheme that the UE is to use. In some embodiments, the single DCI comprises resource information corresponding to a resource allocation to indicate to the UE the resources to use for the PUSCH transmissions. The determination of the resource allocation is made by the base station. In some embodiments, the base station determines the resource allocation based on UE capability. The UE capability can be provided by the UE.

In some embodiments, the resource allocation is in frequency and/or space for a number of different cases. For example, in one case, the resource allocation specifies the resources for transmitting a single PUSCH occasion across different panels. In other words, resources are specified for transmitting a single TB (i.e., the same data) across different UE antenna panels simultaneously. Note that in some embodiments, the transmission of the single TB across different UE antenna panels involves transmitting different coded bits from same TB on different panels. In some other embodiments, the transmission of the single TB across different UE antenna panels involves transmitting same data on different panels. For example, the same data could be modulated differently and its transmission repeated such that one goes through layer 1 while another goes through layer 2 with layer 1 being transmitted by a first antenna panel and layer 2 being transmitted by a second antenna panel. Such transmission would improve diversity.

In another case, the resource allocation specifies the resources for performing repetition of the same TB across different panels. In this instance, the data being transmitted by each antenna panel is different. In a third case, the resource allocation specifies the resources for performing simultaneous PUSCH transmissions of two different TBs. In some embodiments, this involves transmitting two different codewords.

Thus, in some embodiments, the resource allocation is indicated to the UE via a single DCI using a combination of higher layer parameters and a dynamic indication the resource allocation for handling one of the cases above. In some embodiments, the based station first determines the transmission scheme (e.g., SDM, FDM, etc.) that the UE is to use for the multiple PUSCH transmissions, and then after determining the transmission scheme (e.g., SDM, FDM, etc.), the base stations determines whether the multiple simultaneous PUSCH transmissions are for transmitting a single TB, multi-TB or repetition. These resources can be determined by the base station based on the UE capability.

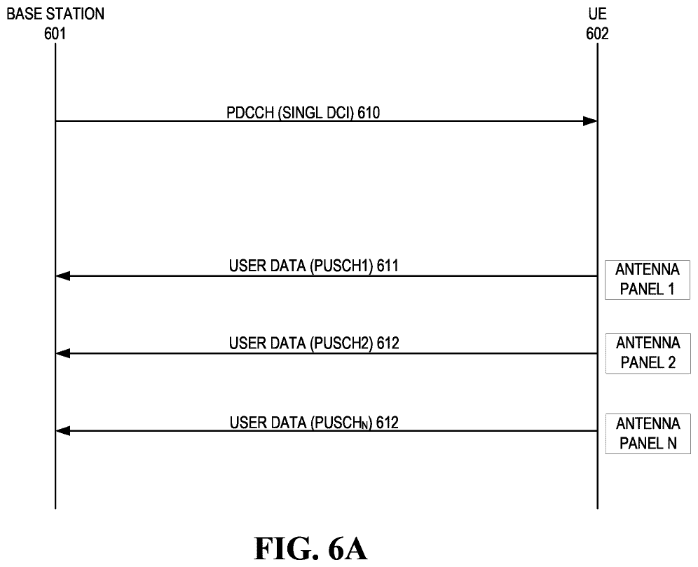

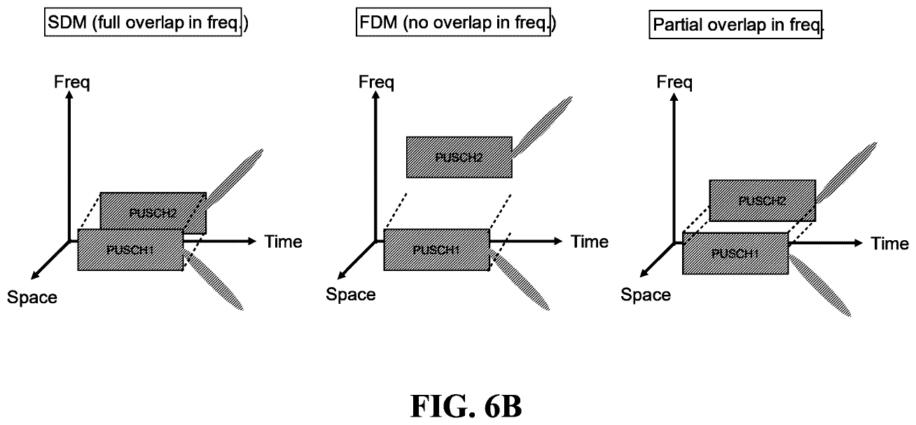

After providing the resource allocation, a determination is made as to the UL beams to be used by the UE for transmissions of the multiple PUSCHs across different panels. FIG. 6A illustrates a data flow diagram of some embodiments of single downlink control information (DCI) resource allocation to support multi-panel simultaneous transmission o of multiple Physical Uplink Shared Channels (PUSCHs) by a UE. Referring to FIG. 6A, base station 601 transmits a single DCI to UE 602. In some embodiments, the single DCI is transmitted as part of PDCCH 610. The single DCI contains an uplink resource allocation for resources to be used by UE 602 to transmit multiple PUSCHs across different panels. In response to the single DCI with the uplink resource allocation, UE 602 transmits user data 611 to base station 601 using its antenna panel 1, user data 612 to base station 601 using its antenna panel 2, . . . , user data 613 to base station 601 using its antenna panel N. In some embodiments, user data 611-613 are transmitted simultaneously by UE 602 using PUSCHs. While FIG. 6A shows N panels being used by UE 602 to transmit the PUCSHs simultaneously, in some embodiments, UE 602 only transmits two PUSCHs simultaneously using two antenna panels. Also, in some other embodiments, the multiple PUCSCHs are transmitted simultaneously to two base stations, with one PUCSH being transmitted to base station 601 and another PUSCH being transmitted to another base station.

In the following description, the following terms may be used:
1. s-DCI: single DCI
2. MPSTx: Multi-Panel Simultaneous Transmission where the UE transmits on multiple of its antenna panels
3. sdmMPTx: Multi-Panel Simultaneous Transmission where the UE transmits on multiple of its antenna panels using Spatial Domain Multiplexing
4. fdmMPTx: Multi-Panel Simultaneous Transmission where the UE transmits on multiple of its antenna panels using Frequency Domain Multiplexing
5. 1sMPTx: one shot (no repetition) transmission of a single transport block (TB) with multi-panel simultaneous transmission (e.g., the UE transmits on multiple of its antenna panels one TB without repetition)
6. ReMPTx: repetition (in frequency and/or space) of a single TB with multi-panel simultaneous transmission (e.g., the UE transmits a single TB with repetition on multiple of its antenna panels)

There are a number of resource allocation schemes that may be used as part of Multi-Panel Simultaneous Transmission for transmitting multiple PUSCHs simultaneously using multiple antenna panels of the UE. Examples of such resource allocation schemes for multi-panel simultaneous transmission are disclosed below. In some embodiments, each of these resource allocation schemes involve allocating resources using a single DCI that specifies an uplink resource allocation for a plurality of Physical Uplink Shared Channels (PUSCHs), wherein the uplink resource allocation for the plurality of PUSCHs is specified, per user equipment (UE) antenna panel.

In some embodiments, the uplink resource allocation for the plurality of PUSCHs is specified using one or more time domain resource allocation (TDRA) and frequency domain resource allocation (FDRA) bit-fields in the single DCI to represent spatial domain resources when the UE is configured to perform simultaneous multi-panel transmission across spatial domain multiplexing (SDM) resources.

More specifically, in some embodiments, for s-DCI, based on, or subject, to the UE capability (e.g., the UE indicating its capability with respect to SDM, FDM or a combination of the two), if UE is configured with a sdmMPTx parameter (via, e.g., RRC configuration information), then multi-panel simultaneous transmission is across SDM resources. In such a case, TDRA and FDRA bit-fields represent resources per panel, where a full resource overlap in time and frequency is assumed for SDM multi-panel simultaneous transmission. FIG. 6B illustrates this case where PUSCH1 represent time and frequency resources associated to panel 1, and PUSCH2 represent time and frequency resources associated to the panel 2, where one occasion is transmitted by panel 1 and one occasion is transmitted by panel 2. Thus, the s-DCI schedules those SDM time and frequency resources for the two panels.

In some embodiments, the uplink resource allocation for the plurality of PUSCHs is specified using one or more time domain resource allocation (TDRA) bit-fields in the single DCI to represent a time domain resource allocation when the UE is configured to perform simultaneous multi-panel transmission across frequency domain multiplexing (FDM) resources or across both FDM resources and SDM resources.

More specifically, in some embodiments, for s-DCI, based on, or subject, to the UE capability (e.g., the UE indicating its capability with respect to SDM, FDM or a combination of the two), if UE is configured with a fdmMPTx parameter (via, e.g., RRC configuration information), then multi-panel simultaneous transmission is across FDM resources. In such a case, for FDM, the s-DCI includes a resource allocation with the same time domain resources for the two occasions where two PUSCHs are transmitted simultaneously (e.g., multi-panel simultaneous transmission is over the same set of symbols). In some embodiments, a TDRA bit-field in DCI represents the time domain resource allocation for all transmissions.

In some embodiments, for both resource allocation type 0 and type 1 when the multi-panel simultaneous transmission is across FDM resources, a new FDRA field in the s-DCI is added and used for the PUSCH scheduling on the 2nd PUSCH.

In some embodiments, the resource allocation is specified to the UE in the s-DCI differently for resource allocation type 0 and resource allocation type 1. Various embodiments for specifying the resource allocation for resource allocation type 0 and resource allocation type 1 are given below.

To indicate the resource allocation to a UE, for resource allocation type 0, the resource allocation includes a bitmap indication of RBGs. In such a case, there are a number of options that may be used to allocation RBGs. In some embodiments, for resource allocation type 0 in frequency domain, the uplink resource allocation specified in the single DCI for the plurality of PUSCHs, allocates non-consecutive resource block groups (RBGs) to each PUSCH of the plurality of PUSCHs. In some embodiments, the non-consecutive RBGs allocated to each PUSCH comprise even RBGs allocated to a first PUSCH and odd-numbered RBGs allocated to a second PUSCH. In some embodiments, in the case of a resource allocation consisting of only one RBG (special case), a first half of RBs belong to PUSCH1 and 2nd half to PUSCH2, where PUSCH1 represent time and frequency resources associated to panel 1, and PUSCH2 represent time and frequency resources associated to the panel 2.

As another option, in some embodiments, for resource allocation type 0 in the frequency domain, the uplink resource allocation specified in the single DCI for the plurality of PUSCHs, includes a resource block (RB) parameter that indicates a size of consecutive physical resource blocks (PRBs) within the allocated RBs assigned to each PUSCH of the plurality of PUSCHs (e.g., PUSCH1, PUSCH2, etc.). In some embodiments, even-numbered groups of consecutive PRBs within the allocated resource blocks (RBs) are assigned to a first PUSCH and odd-numbered groups of consecutive PRBs within the allocated RBs are assigned to a second PUSCH.

In some embodiments, for resource allocation type 0 in the frequency domain, the uplink resource allocation specified in the single DCI for the plurality of PUSCHs, includes a resource block (RB) parameter that indicates a size of consecutive physical resource blocks (PRBs) within the allocated RBs assigned to each PUSCH of the plurality of PUSCHs. In some embodiments, even-numbered groups of consecutive PRBs within the allocated resource blocks (RBs) are assigned to a first PUSCH and odd-numbered groups of consecutive PRBs within the allocated RBs are assigned to a second PUSCH. To this end, in some embodiments, a new RRC parameter RB_{bunle} is used in the s-DCI, which is based on which bandwidth part (BWP) is partitioned into consecutive PRBs of size RB_{bunle}. Note that the first and last bundle sizes can be different than RB_{bunle}. In some embodiments, for FIG. 6B, an even RB_{bunle} within the allocated RBs in the s-DCI are associated with PUSCH1 and the odd RB_{bunle} within the allocated RBs in the s-DCI are associated to PUSCH2.

Note that if the UE indicates that it has capability to both SDM and FDM, in some embodiments, both sdmMPTx parameter and fdmMPTx parameter will be configured, and only one configuration is used.

In some embodiments, the uplink resource allocation in the single DCI for the plurality of PUSCHs for resource allocation type 1 in frequency domain, the s-DCI specifies an allocation of contiguous PRBs for each of the PUSCHs. In some embodiments, for resource allocation type 1, the uplink resource allocation in the single DCI for the plurality of PUSCHs specifies a number of allocated RBs in a FDRA bit-field and a first half of the RBs are assigned to a first PUSCH and a second half of the RBs are assigned to a second PUSCH. In some embodiments, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of a same number of contiguous PRBs for a second PUSCH of the plurality of PUSCHs is indicated by an offset made with respect to an end or start of the resource allocation given by the FDRA bit-field. In some embodiments, the FDRA bit-field indicates N_{PRB} allocated RBs, where ceil (N_{PRB}/2), or alternatively floor (N_{PRB}/2) is assigned to the first PUSCH (FIG. 6B) and the rest of RBs belong to the second PUSCH (FIG. 6B).

In some embodiments, for resource allocation type 1 in frequency domain, the uplink resource allocation in the single DCI for the plurality of PUSCHs indicates the resource allocation of contiguous PRBs for a first PUSCH of the plurality of PUSCHs with a location at which the RBs start and a number of RBs in a FDRA bit-field, and the resource allocation of contiguous PRBs for a second PUSCH of the plurality of PUSCHs is indicated by an offset made with respect to the location at which the RBs allocated for the first PUSCH start modulo a size of a bandwidth part (BWP) containing the contiguous PRBs allocated to the first and second PUSCHs. In some embodiments, the FDRA bit-field indicates the resource allocation associated to the first PUSCH, and the resource allocation for the 2nd PUSCH is determined accordingly, for example, by an offset from the end (or start) of the first resource allocation given by the FDRA bit-field and with either the same number of PRBs (in some embodiments) or to the end (or start) of the BWP (in other embodiments).

In some embodiments, for resource allocation type 1 in frequency domain, the uplink resource allocation in the single DCI for the plurality of PUSCHs indicates a resource allocation of contiguous PRBs for a first PUSCH of the plurality of PUSCHs in a FDRA bit-field, and the resource allocation of contiguous PRBs for a second PUSCH of the plurality of PUSCHs is indicated by an offset made with respect to an end or start of the resource allocation given by the FDRA bit-field to an end or start of a bandwidth part (BWP) containing the contiguous PRBs allocated to the first and second PUSCHs. In some embodiments, the existing procedure for intra-slot frequency hopping is reused to determine the starting RB to each PUSCH (instead of hop), as follows: for the PUSCH1:

RBₛₜₐᵣₜ and L are both given by FDRA bit-field, and for the PUSCH2:

RBₛₜₐᵣₜ=(RBₛₜₐᵣₜ+RB_{offset})mod BWP_{size}.

In some embodiments, for resource allocation type 1 in frequency domain, the uplink resource allocation in the single DCI for the plurality of PUSCHs indicates a resource allocation of contiguous PRBs for a first PUSCH of the plurality of PUSCHs includes a resource block (RB) parameter that indicates a size of consecutive physical resource blocks (PRBs) within the allocated RBs assigned to each PUSCH of the plurality of PUSCHs, wherein even-numbered groups of consecutive PRBs within the allocated resource blocks (RBs) are assigned to a first PUSCH and odd-numbered groups of consecutive PRBs within the allocated RBs are assigned to a second PUSCH. This is the same as the second option for Type 0 FDRA.

Alternatively, in the option where the FDRA bit-field indicates the resource allocation associated to the first PUSCH, and the resource allocation for the 2nd PUSCH is determined accordingly, for example, by an offset from the end (or start) of the first resource allocation given by the FDRA bit-field and with either the same number of PRBs (in some embodiments) and or the previous option that reuses the existing procedure for intra-slot frequency hopping, for those RBs that may overlap in frequency across the two PUSCHs, there are a number of alternatives. In some embodiments, a first alternative is that RBs that overlap in frequency across the two PUSCHs are not usable (i.e. dropped) for both PUSCHs. In some other embodiments, a second alternative is that RBs that overlap in frequency across the two PUSCHs are used for transmission by PUSCH1 only. In some other embodiments, a third alternative is that RBs that overlap in frequency across the two PUSCHs is based on whether the UE indicates its capable of partial overlap transmission, and if so, those RBs are used for simultaneous transmission over both PUSCHs (partial/full overlapping in frequency). FIG. 6B also shows the situation where there is a partial overlap in frequency resources allocated to both PUSCH1 and PUSCH2.

In some embodiments, the uplink resource allocation from the base station for allocating resources for the UE to perform transmission of multiple PUSCHs simultaneously using multiple UE antenna panels (e.g., multi-panel) is specified based on UE capability information that the base station has. In some embodiments, the UE capability information is sent, via the UE, and received, by the base station, by Radio Resource Control (RRC) signaling or via dynamic signaling. In some embodiment, the base station uses RRC signaling to indicate to the UE the transmission scheme it is to use (e.g., SchemeA, SchemeB, SchemeC, etc.). In some embodiments, the base station uses RRC signaling to indicate to the UE multiple transmission schemes it can use (e.g., SchemeA, SchemeB, SchemeC, etc.) and then uses DCI to dynamically indicate which of the multiple schemes it is to use at particular times.

In some embodiments, the UE capability information that is used by the base station when allocating uplink resources for the multi-panel, multiple PUSCHs simultaneous transmission specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, a transmission scheme. In some embodiments, the UE capability information specifies a combination a two or more of the above information. For example, in some embodiments, the UE capability information specifies a combination a number of code blocks supported when a predetermined number of transmission layers are scheduled. In some other embodiments, the UE capability information specifies a combination a number of code blocks per PUSCH transmission occasion when a predetermined number of transmission layers are scheduled.

As part of the resource allocation schemes described herein, in some embodiments, the uplink resource allocation, through the single DCI, specifies the TB calculation and the PUSCH mappings of coded bits to resources (e.g., resource elements). In some embodiments, the TB calculation and the PUSCH mappings are based on the transmission scheme being used when simultaneously transmitting multiple PUSCHs using multiple UE antenna panels. In some embodiments, one of three transmission schemes are employed at any one time. These can include transmission schemes in which a single transport block (TB) is transmitted without repetition, a single TB is transmitted with repetition, and a plurality of TBs are transmitted. In some embodiments, the scheme is selected based on the capability of the UE. In some embodiments, the UE indicates their capability through a combination of radio resource control (RRC) and/or dynamic signaling.

In some embodiments, the uplink resource allocation is sent to a UE by a base station using a single DCI that specifies an uplink resource allocation for the multiple PUSCHs, and includes uplink resources for each PUSCH that include resources for transmitting simultaneously, using a plurality of UE antenna panels, a single transport block (TB) without repetition, the single TB with repetition (in one or both of frequency and space), or a plurality of TBs, based on a UE capability as provided by the UE to the base station. The UE uses the uplink resource allocation to configure itself for transmitting multiple PUSCHs simultaneously using multiple UE antenna panels. After being configured, the UE transmits the single TB without repetition, the single TB with repetition, or multiple TBs using the multiple UE antenna panels via the plurality of antenna panels, with each PUSCH of the plurality of PUSCHs being transmitted on a different UE antenna panel.

In some embodiments, if the UE is configured with a parameter (e.g., a 1sMPTx parameter) that indicates the UE uses the multiple simultaneous transmission of a single TB over the multiple UE antenna panels simultaneously, referred to herein a SchemeA), then the UE transmits a single PUSCH transmission of the TB over all the entire allocated resources, which includes a plurality of PUSCHs (e.g., PUSCH1 and PUSCH2). In some embodiments, the multiple PUSCHs (e.g., PUSCH1, PUSCH2, etc.) are associated with different beams and panels via signaling from the base station.

When the transmission scheme of the UE is to transmit a single TB over the multiple UE antenna panels simultaneously (SchemeA), then the uplink resource allocation indicates that the single TB is calculated across all frequency division multiplexing (FDM) and spatial division multiplexing (SDM) resources of the uplink resource allocation that are to be used for transmitting the single TB using the plurality of UE antenna panels, which assumes that same Modulation Coding Scheme (MCS) and same number of layers, as specified in the single DCI, for transmitting the single TB is applied to all the beams and UE antenna panels. In some embodiments, the uplink resource allocation includes indications of the MCS and number of layers for each UE antenna panel. An example process for TB calculation for this transmission scheme (SchemeA) is described in more detail below.

In some embodiments, the uplink resource allocation for the UE when transmitting a single TB over the multiple UE antenna panels simultaneously (SchemeA) specifies slot-based repetitions with a redundancy version (RV) index per repetition occasion for the UE for beam hopping with the UE antenna panels across time domain (TD) repetitions. In other words, in some embodiments, the UE can still be indicated with slot-based (Type-A) or sub-slot-based (Type-B) repetitions, but per repetition occasion, with all the resources across multiple panels assumed as a single occasion. In some embodiments, the RV indication follows the legacy Revisions 15/16 in in which the RV field in DCI indicates the first RV index, and the RV for the next TD occasions is determined by a mod operation as given by Table 6.1.2.1-2 of 3GPP TS 38.214, Section 6.1.4.2.

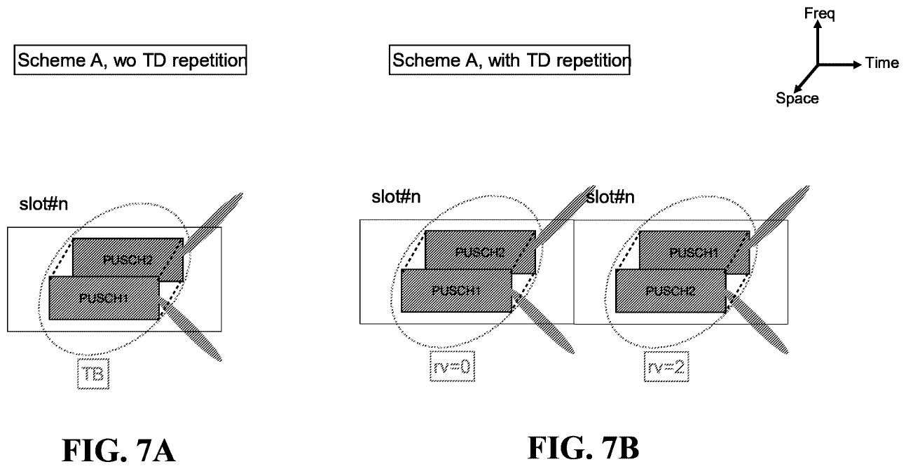

In some embodiments, the beams used for the PUSCHs can hop across time domain repetitions, similar to the patterns described in Revision 17 of NR. In such case, both cyclic and sequential can be supported beam hopping can be used. FIGS. 7A and 7B illustrate examples of the PUSCHs for the first transmission scheme (SchemeA). FIG. 7A illustrates the first transmission scheme transmitting two PUSCHs simultaneously on two UE antenna panels without time domain (TD) repetition. Referring to FIG. 7A, during slot #n, a single TB is transmitted without repetition using PUSCH1 on a first UE antenna panel associated with a first beam and using PUSCH2 on a second, different UE antenna panel associated with a second beam. FIG. 7B illustrates the first transmission scheme transmitting two PUSCHs simultaneously on two UE antenna panels with TD repetition. Referring to FIG. 7B, during slot #n, PUSCH1 is transmitted on the first UE antenna panel associated with a first beam and PUSCH2 is transmitted on a second, different UE antenna panel associated with a second beam, both with RV equal to 0. In slot #n+1, PUSCH1 is transmitted on the second UE antenna panel with the second beam and PUSCH2 is transmitted on the first UE antenna panel with the first beam, both with RV equal to 2.

In some other embodiments, the UE does not expect to receive any additional indications to perform TDM repetition from the base station. In some other embodiments, the transmission of the single TB using multi-slot (TBoMS) is also possible. In this case, the resources are repeated across different times and the TB is calculated across all the resources.

When the transmission scheme of the UE is to transmit a single TB with repetition over the multiple UE antenna panels simultaneously (SchemeB), then the uplink resource allocation indicates the single TB is transmitted with repetition in frequency and/or space. In some embodiments, the resource allocation indicates resources for transmitting two PUSCHs with the same TB (i.e., two repetitions) simultaneously using two different UE antenna panels. In some embodiments, the TB is determined based on resources, MCS and number of layers associated with the PUSCH, and the same resources (e.g., FDRA and TDRA) are used for both PUSCHs. In some embodiments, with this transmission scheme (SchemeB), the uplink resource allocation provides an indication of the MCS and number of layers for the single TB. The indication can be provided for each PUSCH per beam, with a different code rate per repetition. In some embodiments, the multiple PUSCHs (e.g., PUSCH1, PUSCH2, etc.) are associated with different beams and panels via signaling from the base station.

In some embodiments, for this transmission scheme (SchemeB), the uplink resource allocation specifies slot-based repetitions with a redundancy version (RV) index for repetitions for each PUSCH of the plurality of PUSCHs without time domain repetitions. For two PUSCH repetitions, the RV is determined by Table 6.1.2.1-2 of 3GPP TS 38.214, where n=0, 1 is applied respectively to the first and second PUSCHs (or vice versa). In this case, UE does not expect to receive additional information from the base station to perform time domain repetitions.

In some other embodiments, for this transmission scheme (SchemeB), the uplink resource allocation specifies slot-based repetitions with a redundancy version (RV) index per repetition occasion for the UE for beam hopping with the plurality of UE antenna panels across time domain repetitions. In this case, a first RV for PUSCH repetitions associated with a first UE antenna panel is based on a count of PUSCH transmission occasions associated with the first UE antenna panel and a second RV associated with a second UE antenna panel being based on the first RV and an offset. That is, the UE can also be indicated with slot-based (Type-A) or sub-slot-based (Type-B) repetitions, where RV indication follows legacy Revision 17 of NR, by counting n separately for repetition occasions associated to each PUSCH. For all PUSCH repetitions associated with the first UE antenna panel, the RV is derived according to Table 6.1.2.1-2 of 3GPP TS 38.214, where n is counted only considering PUSCH transmission occasions associated with the first panel In some embodiments, for all PUSCH repetitions associated with a second UE antenna panel, the RV is derived according to Table 6.1.2.1-3 of 3GPP TS 38.214, where n is counted only considering PUSCH transmission occasions associated with the second panel AND additional shifting operation for each redundancy version is applied by RRC parameter sequenceOffsetforRV.

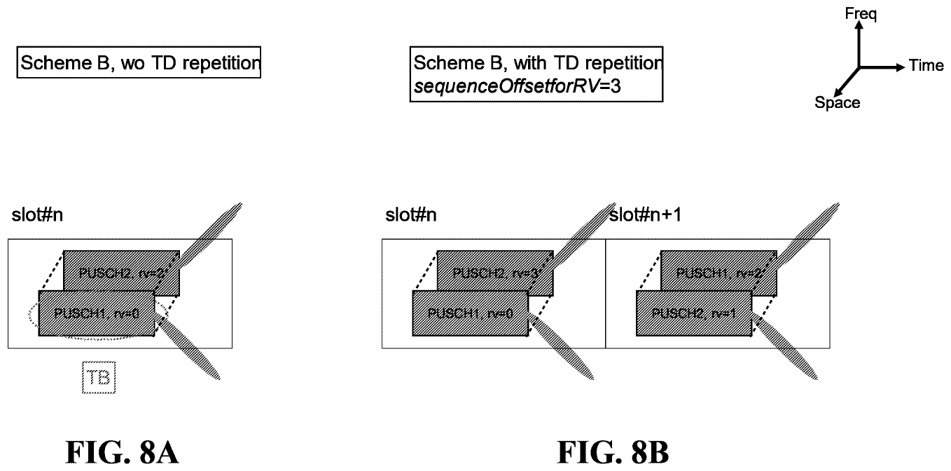

FIGS. 8A and 8B illustrate examples of the second transmission scheme (Scheme B), including the use of sequenceOffsetforRV=3. FIG. 8A illustrates the second transmission scheme transmitting two PUSCHs simultaneously on two UE antenna panels without time domain (TD) repetition. Referring to FIG. 8A, during slot #n, a single TB is transmitted with repetition using PUSCH1 on a first UE antenna panel associated with a first beam (one repetition) and using PUSCH2 on a second, different UE antenna panel associated with a second beam (one repetition). Each of PUSCH1 and PUSCH2 has a different RV (i.e., PUSCH1 with RV=0, PUSCH2 with RV=2). FIG. 8B illustrates the second transmission scheme transmitting two PUSCHs simultaneously on two UE antenna panels with TD repetition. Referring to FIG. 8B, during slot #n, PUSCH1 is transmitted on the first UE antenna panel associated with a first beam and PUSCH2 is transmitted on a second, different UE antenna panel associated with a second beam. In this case, PUSCH1 has an RV equal to 0. The sequenceOffsetforRV is set to 3 as the offset. Therefore, the RV for PUSCH2 is 3. In slot #n+1, PUSCH1 is transmitted on the second UE antenna panel associated with the second beam and PUSCH2 is transmitted on the first UE antenna panel associated with the first beam. In this case, the RV for PUSCH1 becomes 2 and the RV for PUSCH2 becomes 1 (e.g., 2 (RV for PUSCH1)+3(RV offset) modulo equals 1). Thus, FIG. 8B shows how the beams are rotating across different PUSCHs across time and frequency/space.

Note that the UE does not expect to receive any additional indications from the base station to perform TB over multi-slot (TBoMS) for this transmission scheme (SchemeB).

When the transmission scheme of the UE is to transmit a plurality of TBs over the multiple UE antenna panels simultaneously (SchemeC), then the uplink resource allocation indicates which TB of the plurality of TBs is associated with which PUSCH of the plurality of PUSCHs. For example, in some embodiments, if the UE is configured with maxNrofCodeWordsScheduledByDCI with a value of 2, the UE can transmit two PUSCHs of separate TBs, where a first TB is associated with PUSCH1 and a second TB is associated with PUSCH2.

In some embodiments, for this transmission scheme (SchemeC), the resource allocation indicates a MCS and number of layers for each TB (each TB has its own MCS and its own number of layers). If both TBs are enabled, TB1 and TB2 are determined based on resources associated to PUSCH1 and PUSCH2, and the MCS and number of layers associated to PUSCH1 and PUSCH2. In some embodiments, the uplink resource allocation includes downlink control information (DCI) bitfields to specify one or more of MCS, NDI and RV associated with each codeword of the plurality of codewords being transmitted simultaneously using the multiple UE antenna panels. For example, in the case of transmitting two TBs simultaneously using PUSCH1 and PUSCH2 with two UE antenna panels, new bitfields are used to indicate the MCS, a New Data Indicator (NDI), and an RV associated to the second CW. Thus, the indications are provided per codeword.

In some embodiments, for this transmission scheme (SchemeC), the uplink resource allocation specifies slot-based repetitions with a redundancy version (RV) index for repetition occasions associated with each UE antenna panel for the plurality of PUSCHs. In some embodiments, the RV indication follows legacy Revision 17 of NR, by counting n separately for repetition occasions associated to each beam/panel. Repetition in time domain (TD) is performed similar to Revision 16 of NR, but with beam hopping (both cyclic and sequential patterns).

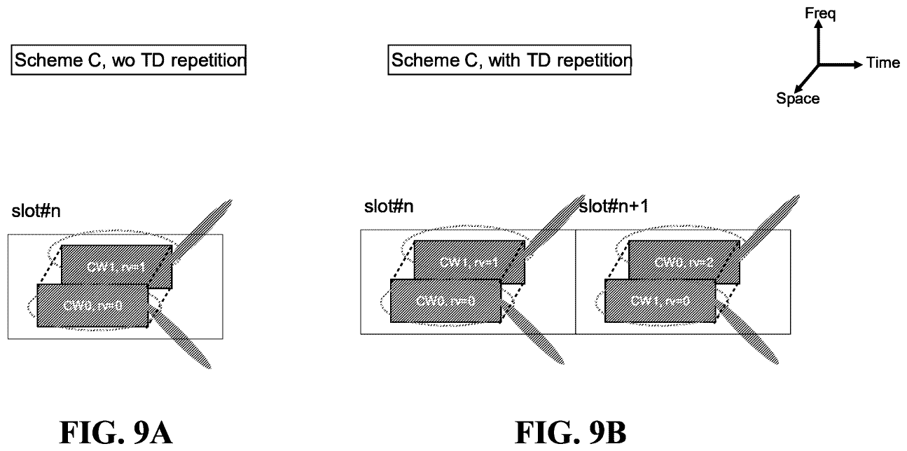

FIGS. 9A and 9B illustrate examples of this transmission scheme (SchemeC). FIG. 9A illustrates the third transmission scheme transmitting two PUSCHs with two TBs simultaneously on two UE antenna panels without time domain (TD) repetition. Referring to FIG. 9A, during slot #n, a first TB for the first codeword is transmitted using PUSCH1 on a first UE antenna panel associated with a first beam and a second TB for the second codeword is transmitted using PUSCH2 on a second, different UE antenna panel associated with a second beam (one repetition). Each of PUSCH1 and PUSCH2 has a different RV (i.e., PUSCH1 with RV=0, PUSCH2 with RV=1). FIG. 9B illustrates the second transmission scheme transmitting two PUSCHs simultaneously on two UE antenna panels. Referring to FIG. 9B, during slot #n, PUSCH1 with codeword 0 (CW0) is transmitted on the first UE antenna panel associated with a first beam and PUSCH2 with codeword 1 (CW1) is transmitted on a second, different UE antenna panel associated with a second beam. In this case, PUSCH1 and CW0 has an RV equal to 0, while PUSCH2 and CW1 has an RV equal to 1. In slot #n+1, CW0 is transmitted on the second UE antenna panel associated with the second beam and CW1 is transmitted on the first UE antenna panel associated with the first beam. In this case, the RV for CW0 becomes 2 and the RV for CW1 is 0. Thus, the codewords CW0 and CW1 hop to the other panels, such that the same codeword is transmitted with different beams when changing slots.

Note that the UE does not expect to receive any additional indications from the base station to perform TB over multi-slot (TBoMS) for this transmission scheme (SchemeC).

Ins some embodiment, the UE receives an indication, from the base station, specifying whether the uplink resource allocation is with resources for transmitting simultaneously, using a plurality of UE antenna panels, the single TB without repetition, the single TB with repetition, or a plurality of TBs (e.g., transmission SchemeA, SchemeB, SchemeC). In some embodiments, the configuration is subject to the UE capability. If UE is capable of multiple schemes, only one scheme is signaled by the base station to the UE. In some embodiments, this signaling is via RRC. In some other embodiments, the transmission scheme is dynamically indicated by the base station via scheduling a DCI Format to support fast adaptation. For example, such signaling can be performed based on the traffic type associated with the PUSCH (e.g., URLLC vs. eMBB).

When the transmission scheme of the UE is to transmit a single PUSCH transmission of a TB without repetition over multi-panel simultaneously using multiple UE antenna panels (SchemeA), then the TB calculation and PUSCH construction are as follows. If a single MCS bit-field and number of layers is applied to the UE antenna panels (e.g., both UE antenna panels when using two UE antenna panels,) the single PUSCH transmission of the TB is calculated according to 3GPP TS 38.214 Section 6.1.4.2 where n_{PRB} is the total number of allocated PRBs across all of the UE antenna panels. The overlapped RBs may be counted once or twice.

In some embodiments, in the case of a single PUSCH transmission of a TB without repetition, PUSCH construction is performed according to the PUSCH construction set forth in 3GPP TS 38.211, Section 6.3.1 except that the PUSCHs are applied different beams and/or precoding. For example, when two PUSCHs, such as PUSCH1 and PUSCH2, are being transmitted simultaneously, these are applied to different beams and/or have different precoding. Note that this applies to both FDM and SDM.

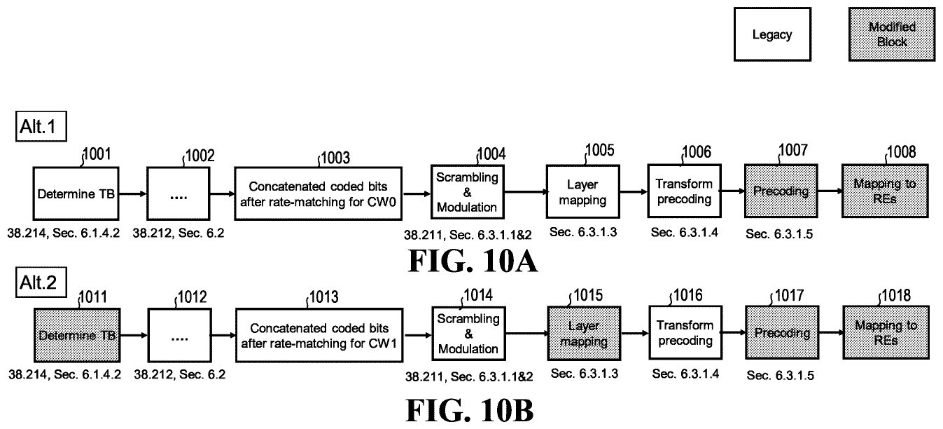

In some embodiments, when the single MCS bit-field and number of layers is applied to the UE antenna panels, the mapping of the coded bits to the resources can be performed in a number of different ways. In some embodiments, when two PUSCH transmissions are to occur (e.g., PUSCH1 and PUSCH2), then the mapping starts with the first allocated symbol, and the coded symbols are mapped in frequency first to all resource elements (REs) associated to PUSCH1 and next to resource elements (REs) associated to PUSCH2. Then, the mapping moves to the next symbol. In some other embodiments, the mapping starts with PUSCH1, where coded bits are mapped in all frequency and time REs associated to PUSCH1 (frequency next time), and the mapping moves to the next PUSCH, such as PUSCH2. In some other embodiments, for FDM, the mapping begins with the first allocated symbol, and the coded symbols are mapped to all REs (that belong to PUSCH1 and PUSCH2) in frequency, and then next to the next symbol and so on. FIG. 10A illustrates an example of this PUSCH mapping scheme for this transmission scheme (SchemeA).

Referring to FIG. 10A, the transmission chain first determines the TB (1001). In some embodiments, the determination of the TB is performed according to 3GPP TS 38.214, Section 6.1.4.2. Next, multiplexing and channel coding are performed (1002). In some embodiments, multiplexing and channel coding are performed according to 3GPP TS 38.212, Section 6.2. Thereafter, coded bits are concatenated after rate matching for codeword 0 (CW0). After concatenation, scrambling and modulation are performed (1004) followed by layer mapping (1005) and transform precoding (1006). In some embodiments, scrambling and modulation are performed according to 3GPP TS 38.211, Section 6.3.1.1 and 6.3.1.2. In some embodiments, layer mapping is performed according to 3GPP TS 38.211, Section 6.3.3. In some embodiments, transform precoding is performed according to 3GPP TS 38.211, Section 6.3.1.4. Once transform precoding is done, precoding is performed (1007). In some embodiments, precoding is performed according to 3GPP TS 38.211, Section 6.3.1.5 except if the uplink is codebook based, the codebook is applied to the layer associated with the PUSCH (per PUSCH). After precoding, the coded symbols are mapped to all REs that belong to the PUSCHs (e.g., PUSCH1 and PUSCH2 for the case of two simultaneously transmitted PUSCHs) in frequency (FDM) (1008). Thus, the precoding (1007) and the mapping to REs (1008) are performed differently for this transmission scheme than the legacy PUSCH mapping.

In some other embodiments, the TB calculation and PUSCH construction for this transmission scheme (SchemeA) are performed in a different manner if the MCS and/or number of layers is separately indicated per panel/beam. In such a case, for the TB calculation, the single TB calculation is based on separate TB calculations for each of the UE antenna panels according to 3GPP TS 38.214 Section 6.1.4.2 using a number of allocated PRBs associated with each of the plurality of UE antenna panels. That is, for TB calculation: TB=TB₁+TB₂, both TB₁ and TB₂ are determined using 38.214, Sec. 6.1.4.2, where n_{PRB} for TB₁ is the total number of allocated PRBs associated to the first PUSCH (PUSCH1), TB₂ is the total number of allocated PRBs associated to the second PUSCH (PUSCH2), etc. Also, the PUSCH mapping to resource elements is determined by assigned PRBs corresponding to each beam for its respective PUSCH of the multiple PUSCHs. In the case of simultaneously transmitting two PUSCHs, the PUSCH transmission is decomposed into two transmissions, each associated to one of the panels/beams, where each transmission follows 38.211, Section 6.3.1 for the given modulation order and number of layers. FIG. 10B illustrates an example of this mapping scheme for this transmission scheme (SchemeA).

FIG. 10B illustrates an example of this PUSCH mapping scheme for this transmission scheme (SchemeA). Referring to FIG. 10B, in this alternative, the transmission chain first determines the TB (1011). In some embodiments, the determination of the TB is performed according to 3GPP TS 38.214, Section 6.1.4.2. As discussed above, in this alternative, for TB calculation, the TB equals TB₁+TB₂, and both TB₁ and TB₂ are determined using 38.214, Sec. 6.1.4.2, where n_{PRB} for TB₁ is the total number of allocated PRBs associated to the first PUSCH (PUSCH1), TB₂ is the total number of allocated PRBs associated to the second PUSCH (PUSCH2), etc. Next, multiplexing and channel coding are performed (1012). In some embodiments, multiplexing and channel coding are performed according to 3GPP TS 38.212, Section 6.2. Thereafter, coded bits are concatenated after rate matching for codeword 0 (CW0). After concatenation, scrambling and modulation are performed (1014) followed by layer mapping (1015) and transform precoding (1016). In some embodiments, scrambling and modulation are performed according to 3GPP TS 38.211, Section 6.3.1.1 and 6.3.1.2. In some embodiments, layer mapping is performed according to 3GPP TS 38.211, Section 6.3.3, where the PUSCH transmissions are each associated to one of the panels/beams, and with a given modulation order and number of layers. In some embodiments, transform precoding is performed according to 3GPP TS 38.211, Section 6.3.1.4. Once transform precoding is done, precoding is performed (1017). In some embodiments, precoding is performed according to 3GPP TS 38.211, Section 6.3.1.5 except if the uplink is codebook based, the codebook is applied to the layer associated with the PUSCH (per PUSCH). After precoding, the coded symbols are mapped to all REs that belong to the PUSCHs (e.g., PUSCH1 and PUSCH2 for the case of two simultaneously transmitted PUSCHs) in frequency (FDM) (1018). Thus, the TB determination (1011), layer mapping (1015) precoding (1017), and the mapping to REs (1018) are performed differently for this transmission scheme than the legacy PUSCH mapping.

When the transmission scheme of the UE is to transmit multiple PUSCH transmissions (e.g., two PUSCH transmissions) of the same TB over multiple UE antenna panels simultaneously (SchemeB), then the TB calculation and PUSCH construction are as follows. In some embodiments, the calculation of the TB is based on resource elements (REs), MCS, and number of layers associated with each beam to be transmitted by the UE antenna panels or the TB with the maximum transport block size (TBS) of the TBs calculated for each beam/panel (e.g., the TB that is the maximum TBS for first and second panels when simultaneously transmitting two PUSCHs with two UE antenna panels) or the TB with the minimum TBS of the TBs calculated for each beam/panel (e.g., the TB that is the minimum TBS for first and second panels when simultaneously transmitting two PUSCHs with two UE antenna panels). For example, for the case of simultaneously transmitting two PUSCHs with the same TB, when performing the TB calculation, the TB for the first UE antenna panel is determined as given by 3GPP TS 38.214, Section 6.1.4.2, based on REs, MCS and the number of layers, associated to the first beam of a first UE antenna panel, and the TB for the second UE antenna panel is determined as given by 3GPP TS 38.214, Section 6.1.4.2, based on REs, MCS and the number of layers, associated to the second beam of a second UE antenna panel, or the TB with the maximum of the two TBs calculated for each beam/panel, or minimum of the two TBs calculated for each beam/panel.

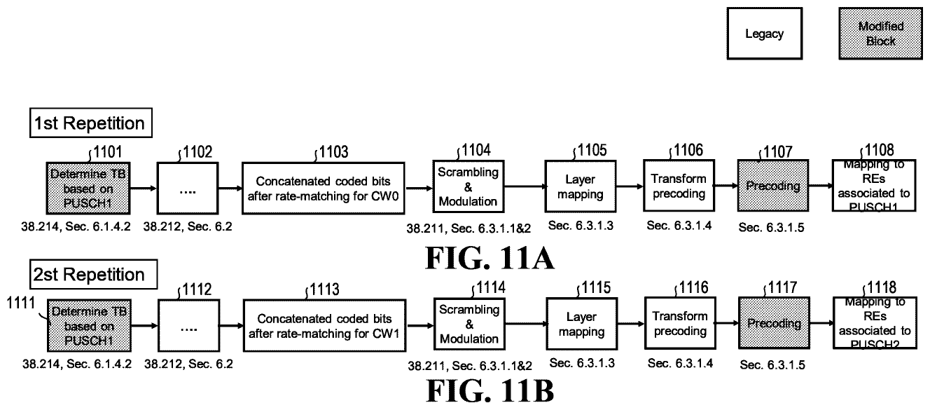

In some embodiments, when transmitting multiple PUSCH transmissions (e.g., two PUSCH transmissions) of the same TB over multiple UE antenna panels simultaneously (SchemeB), for PUSCH construction, the PUSCH mapping to resource elements is determined by assigning PRBs corresponding to each beam for its respective PUSCH. For example, when performing PUSCH construction, the construction of each PUSCH repetition is according to 3GPP TS 38.211, Section 6.3.1 with the mapping to resource elements determined by the assigned PRBs corresponding to each beam. Note that this is the same FDM and SDM (no change in PUSCH RE mapping). FIGS. 11A and 11B illustrate an example of PUSCH mapping for each repetition when transmitting two PUSCH transmissions (e.g., PUSCH1 and PUSCH2) of the same TB over multiple UE antenna panels simultaneously (SchemeB). Referring to FIG. 11A, the transmission chain of the first TB repetition initially determines the TB based on PUSCH1 (1101). In some embodiments, the determination of the TB is performed according to 3GPP TS 38.214, Section 6.1.4.2. Next, multiplexing and channel coding are performed (1102). In some embodiments, multiplexing and channel coding are performed according to 3GPP TS 38.212, Section 6.2. Thereafter, coded bits are concatenated after rate matching for codeword 0 (CW0). After concatenation, scrambling and modulation are performed (1104) followed by layer mapping (1105) and transform precoding (1106). In some embodiments, scrambling and modulation are performed according to 3GPP TS 38.211, Section 6.3.1.1 and 6.3.1.2. In some embodiments, layer mapping is performed according to 3GPP TS 38.211, Section 6.3.3. In some embodiments, transform precoding is performed according to 3GPP TS 38.211, Section 6.3.1.4. Once transform precoding is done, precoding is performed (1107). In some embodiments, precoding is performed according to 3GPP TS 38.211, Section 6.3.1.5. After precoding, the coded symbols are mapped to all REs associated with PUSCH1 (1108). Thus, the TB determination (1101) and precoding (1107) are performed differently for this transmission scheme than the legacy PUSCH mapping.

Referring to FIG. 11B, the transmission chain of the second TB repetition initially determines the TB based on PUSCH2 (1111). In some embodiments, the determination of the TB is performed according to 3GPP TS 38.214, Section 6.1.4.2. Next, multiplexing and channel coding are performed (1112). In some embodiments, multiplexing and channel coding are performed according to 3GPP TS 38.212, Section 6.2. Thereafter, coded bits are concatenated after rate matching for codeword 1 (CW1). After concatenation, scrambling and modulation are performed (1114) followed by layer mapping (1115) and transform precoding (1116). In some embodiments, scrambling and modulation are performed according to 3GPP TS 38.211, Section 6.3.1.1 and 6.3.1.2. In some embodiments, layer mapping is performed according to 3GPP TS 38.211, Section 6.3.3. In some embodiments, transform precoding is performed according to 3GPP TS 38.211, Section 6.3.1.4. Once transform precoding is done, precoding is performed (1117). In some embodiments, precoding is performed according to 3GPP TS 38.211, Section 6.3.1.5. After precoding, the coded symbols are mapped to all REs associated with PUSCH2 (1118). Thus, the TB determination (1111) and precoding (1117) are performed differently for this transmission scheme than the legacy PUSCH mapping.

When the transmission scheme of the UE is to transmit multiple PUSCH transmissions (e.g., two PUSCH transmissions) of multiple TBs (e.g., two TBs) simultaneously using multiple UE antenna panels (SchemeC), then the TB calculation and PUSCH construction are as follows. In some embodiments, for this transmission scheme, the MCS and/or the number of layers is separately indicated per panel/beam. In some embodiments, for TB calculation, the single TB calculation is based separate TB calculations for each of the UE antenna panels and the calculations are according to 3GPP TS 38.214 Section 6.1.4.2. For example, in some embodiments, when two PUSCHs are being transmitted simultaneously with two UE antenna panels, the TB1 for the first UE antenna panel is calculated according to 3GPP TS 38.214 and the TB2 for the second UE antenna panel is calculated according to 3GPP TS 38.214. In these cases, the nPRB of each separate TB calculation for each UE antenna panel is a number of allocated PRBs associated with said each UE antenna panel and the code rate, modulation order and rank for said each separate TB calculation is obtained by an MCS and number of layers indicated for said each separate TB calculation. Thus, the TB calculation to determine TB₁ and TB₂ is determined according to 3GPP TS 38.214, Sec. 6.1.4.2, where n_{PRB} for TB₁ and TB₂ are the total number of allocated PRBs associated to the first and second panels, respectively, and R & Qₘ & v (code rate, modulation order, rank) for TB₁ and TB₂ are obtained by MCS and the number of layers for TB₁ and TB₂, respectively.

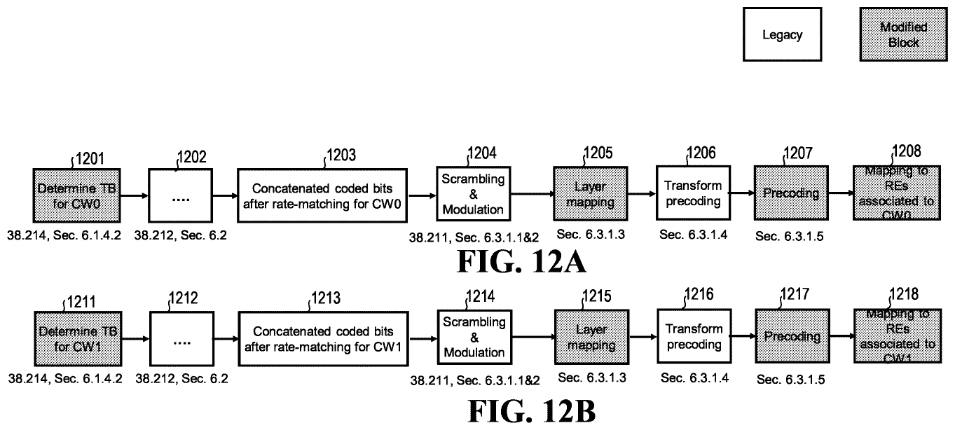

In some embodiments, in the case of transmitting multiple PUSCH transmissions (e.g., two PUSCH transmissions) of multiple TBs (e.g., two TBs) simultaneously using multiple UE antenna panels (SchemeC), for PUSCH construction, the PUSCH transmission is decomposed into different transmissions (e.g., two transmissions for PUSCH1 and PUSCH2), with each associated to one of the panels/beams, where each transmission is according to 3GPP TS 38.211, Sec. 6.3.1 for the given modulation order and number of layers. FIGS. 12A and 12B illustrate an example of PUSCH mapping for two codewords when transmitting two PUSCHs (e.g., PUSCH1 and PUSCH2) over multiple UE antenna panels simultaneously (SchemeC). Note that the same is performed for FDM and SDM.

Referring to FIG. 12A, the transmission chain of the first codeword transmission initially determines the TB for codeword 0 (CW0) (1201). In some embodiments, the determination of the TB is performed according to 3GPP TS 38.214, Section 6.1.4.2. Next, multiplexing and channel coding are performed (1202). In some embodiments, multiplexing and channel coding are performed according to 3GPP TS 38.212, Section 6.2. Thereafter, coded bits are concatenated after rate matching for CW0. After concatenation, scrambling and modulation are performed (1204) followed by layer mapping (1205) and transform precoding (1206). In some embodiments, scrambling and modulation are performed according to 3GPP TS 38.211, Section 6.3.1.1 and 6.3.1.2. In some embodiments, layer mapping is performed according to 3GPP TS 38.211, Section 6.3.3 with the transmission of CW0 being for a given modulation order and number of layers. In some embodiments, transform precoding is performed according to 3GPP TS 38.211, Section 6.3.1.4. Once transform precoding is done, precoding is performed (1207). In some embodiments, precoding is performed according to 3GPP TS 38.211, Section 6.3.1.5 except the application is applied per PUSCH (e.g., if the uplink is codebook based, the codebook is applied to the layer associated with the PUSCH). After precoding, the coded symbols are mapped to REs associated to CW0 (1208). Thus, the TB determination (1201), layer mapping (1205), precoding (1107), and mapping to REs (1208) are performed differently for this transmission scheme than the legacy PUSCH mapping as they are performed for one TB of multiple TBs being transmitted simultaneously using multiple antenna panels of the UE.

Referring to FIG. 12B, the transmission chain of the first codeword transmission initially determines the TB for codeword 1 (CW1) (1211). In some embodiments, the determination of the TB is performed according to 3GPP TS 38.214, Section 6.1.4.2. Next, multiplexing and channel coding are performed (1212). In some embodiments, multiplexing and channel coding are performed according to 3GPP TS 38.212, Section 6.2. Thereafter, coded bits are concatenated after rate matching for CW1. After concatenation, scrambling and modulation are performed (1214) followed by layer mapping (1215) and transform precoding (1216). In some embodiments, scrambling and modulation are performed according to 3GPP TS 38.211, Section 6.3.1.1 and 6.3.1.2. In some embodiments, layer mapping is performed according to 3GPP TS 38.211, Section 6.3.3 with the transmission of CW1 being for a given modulation order and number of layers. In some embodiments, transform precoding is performed according to 3GPP TS 38.211, Section 6.3.1.4. Once transform precoding is done, precoding is performed (1217). In some embodiments, precoding is performed according to 3GPP TS 38.211, Section 6.3.1.5 except the application is applied per PUSCH (e.g., if the uplink is codebook based, the codebook is applied to the layer associated with the PUSCH). After precoding, the coded symbols are mapped to REs associated to CW1 (1218). Thus, the TB determination (1211), layer mapping (1215), precoding (1217), and mapping to REs (1218) are performed differently for this transmission scheme than the legacy PUSCH mapping as they are performed for the TB for each codeword (of multiple TBs) being transmitted simultaneously using multiple antenna panels of the UE.

In some embodiments, regardless of whether using one of the three transmission schemes described above (e.g., SchemeA, SchemeB, SchemeC), if UE has indicated it can perform multi-panel simultaneous transmission, subject to UE capability, the UE only supports inter-slot frequency hopping. For example, in some embodiments, when information multiple PUSCHs, with each PUSCH being transmitted on a different UE antenna panel, the transmissions over a number of slots occurs with frequency hopping. The frequency hopping can be inter-slot frequency hopping. In some other embodiments, inter-slot (and/or intra-slot) frequency hopping is supported only if the UE is configured with a parameter indicating is performs FDM and (e.g., the fdmMPTx parameter is set) in combination with one shot (no repetition) simultaneous transmission of a single TB with multiple UE antenna panels.

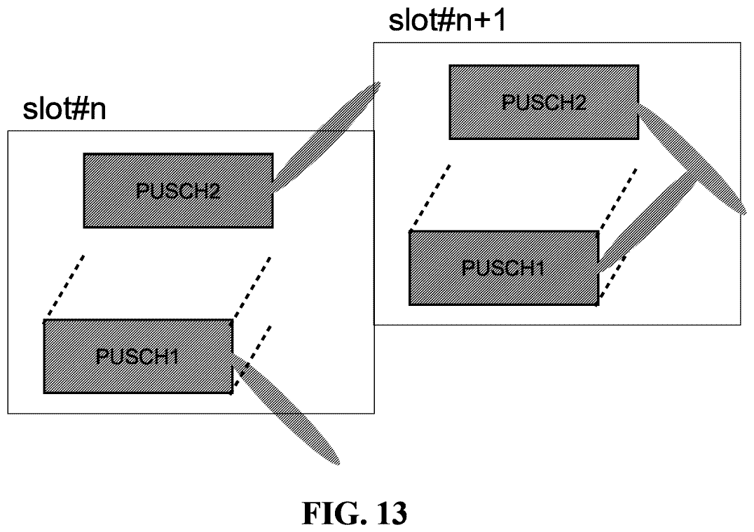

FIG. 13 illustrates an example of frequency hopping for a multi-panel simultaneous transmission involving the transmission of a single TB with repetition (SchemeB) as described above. Referring to FIG. 13, during slot #n, PUSCH1 and PUSCH2 are shown being transmitted from different panels with different beams, while in slot #n+1, PUSCH1 and PUSCH2 have undergone beam hopping and frequency hopping so that they are being transmitted from different panels.

In some other embodiments, neither intra-slot nor inter-slot frequency is supported by the UE.

In some embodiments, a baseband processor (or UE) is configured to perform operations comprising: receiving an RRC configuration information from a base station, wherein the RRC configuration information comprises an uplink transmission scheme using multiple antenna panels for transmitting multiple PUSCHs simultaneously using the plurality of the UE antenna panels, wherein the uplink transmission scheme using multiple antenna panels comprises transmission of a single TB without repetition, transmission of a single TB with repetition, or transmission of a plurality of TBs, based on a user equipment (UE) capability. In some embodiments, the baseband processor also receives a single downlink control information (DCI) that specifies an uplink resource allocation for a plurality of PUSCHs and transmits the plurality of PUSCHs.

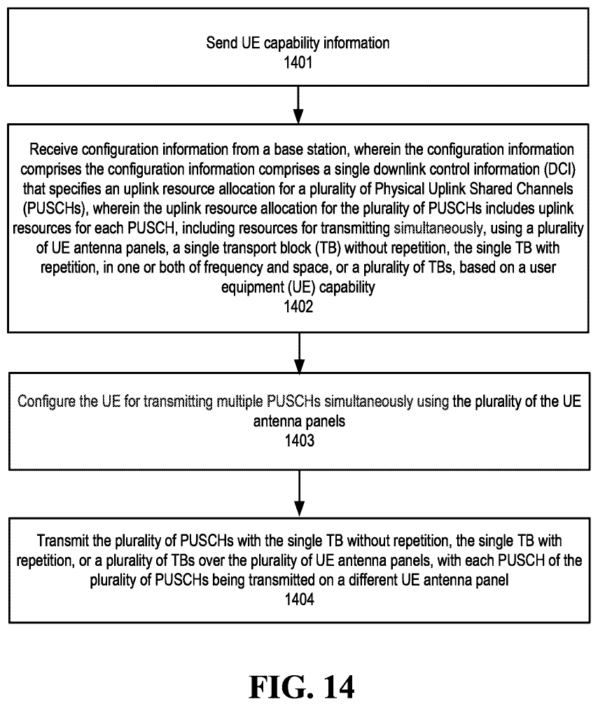

FIG. 14 is a flow diagram of some embodiments of a process for configuring a UE. The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by a UE in a 5G NR communication system. In some embodiments, the process is performed by a UE in a 5G NR communication system comprising a processor (or processing circuitry) and/or a baseband processor in a 5G NR communication system configured to perform the following operations.

Referring to FIG. 14, the process begins by sending UE capability information (processing block 1401). In some embodiments, the UE capability information is sent, via the UE, and received, by the base station, by Radio Resource Control (RRC) signaling or via dynamic signaling.

In some embodiments, in case where the UE is capable of using multiple transmission schemes such as those described herein (e.g., SchemeA, Scheme B, SchemeC, etc.), the UE may receive an indication, from a base station, specifying whether the uplink resource allocation is with resources for transmitting simultaneously, using a plurality of UE antenna panels, the single TB without repetition, the single TB with repetition, or a plurality of TBs. In some embodiments, the UE receives the indication through Radio Resource Control (RRC) signaling. In some embodiments, the UE may receive a dynamic DCI indication, from a base station, specifying whether the uplink resource allocation is with resources for transmitting simultaneously, using a plurality of UE antenna panels, the single TB without repetition, the single TB with repetition, or a plurality of TBs.

In some embodiments, the UE capability information specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, a transmission scheme. In some embodiments, the UE capability information specifies a combination a number of code blocks supported when a predetermined number of transmission layers are scheduled. In some embodiments, the UE capability information specifies a combination a number of code blocks per PUSCH transmission occasion when a predetermined number of transmission layers are scheduled.

Processing logic receives an RRC configuration information from a base station, wherein the RRC configuration information comprises an uplink transmission scheme using multiple antenna panels for transmitting multiple PUSCHs simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability. Processing logic also receives a single downlink control information (DCI) that specifies an uplink resource allocation for a plurality of Physical Uplink Shared Channels (PUSCHs) (processing block 1402). In some embodiments, the transmission scheme is for the plurality of PUSCHs for transmitting simultaneously, using a plurality of UE antenna panels, a single transport block (TB) without repetition, the single TB with repetition, in one or both of frequency and space, or a plurality of TBs, based on a user equipment (UE) capability.

In some embodiments, if the RRC configuration information comprises an uplink transmission scheme for transmitting multiple PUSCHs simultaneously using the plurality of the UE antenna panels comprises transmission of a single transport block (TB) without repetition (e.g., SchemeA), then the single TB is calculated across all frequency division multiplexing (FDM) and spatial division multiplexing (SDM) resources of the uplink resource allocation that are to be used for transmitting the single TB using the plurality of UE antenna panels and indicates a same Modulation Coding Scheme (MCS) and same number of layers for transmitting the single TB with the plurality of UE antenna panels. In some embodiments, the uplink resource allocation specifies slot-based repetitions with a redundancy version (RV) index per repetition occasion for the UE for beam hopping with the plurality of UE antenna panels across time domain repetitions. In some embodiments, if the RRC configuration information comprises an uplink transmission scheme for transmitting multiple PUSCHs simultaneously using the plurality of the UE antenna panels comprises transmission of the single TB without repetition (e.g., SchemeA), then the single TB is calculated across all frequency division multiplexing (FDM) and spatial division multiplexing (SDM) resources of the uplink resource allocation that are to be used for transmitting the single TB using the plurality of UE antenna panels and indicates a Modulation Coding Scheme (MCS) and number of layers for each UE antenna panel for transmitting the single TB with the plurality of UE antenna panels.

In some embodiments, in a transmission scheme like SchemeA, when a single MCS bit-field and number of layers is applied to the plurality of UE antenna panels, the single TB is calculated according to 3GPP TS 38.214 Section 6.1.4.2 using a total number of allocated PRBs across all of the plurality of UE antenna panels. In some embodiments, when the MCS and number of layers is separately indicated for each UE antenna panel of the plurality of UE antenna panels, the single TB calculation is based on separate TB calculations for each of the UE antenna panels according to 3GPP TS 38.214 Section 6.1.4.2 using a number of allocated PRBs associated with each of the plurality of UE antenna panels. In some embodiments, in a transmission scheme like SchemeA, PUSCH mapping to resource elements is determined by assigned PRBs corresponding to each beam for its respective PUSCH of the plurality of PUSCHs.

In some embodiments, in a transmission scheme like SchemeA, transmitting the plurality of PUSCHs, with each PUSCH of the plurality of PUSCHs being transmitted on a different UE antenna panel, is performed as part of transmitting multiple TBs using multiple slots using inter-slot frequency hopping.

In some embodiments, in a transmission scheme like SchemeB, if the RRC configuration information comprises an uplink transmission scheme for transmitting multiple PUSCHs simultaneously using the plurality of the UE antenna panels comprises transmission of the single TB with repetition, then transmission occurs in one or both of frequency and space. In some embodiments, in a transmission scheme like SchemeB, the RRC configuration information comprises an uplink transmission scheme for transmitting multiple PUSCHs simultaneously using the plurality of the UE antenna panels comprises transmission of the single TB with repetition, then the uplink resource allocation specifies the same resources, MCS and a number of layers for the single TB for each PUSCH per beam, with a different code rate per repetition. In some embodiments, the uplink resource allocation specifies slot-based repetitions with a redundancy version (RV) index for repetitions for each PUSCH of the plurality of PUSCHs without time domain repetitions. In some embodiments, the uplink resource allocation specifies slot-based repetitions with a redundancy version (RV) index per repetition occasion for the UE for beam hopping with the plurality of UE antenna panels across time domain repetitions, with a first RV for PUSCH repetitions associated with a first UE antenna panel being based on a count of PUSCH transmission occasions associated with the first UE antenna panel and a second RV associated with a second UE antenna panel being based on the first RV and an offset.

In some embodiments, in a transmission scheme like SchemeB, the calculation of the TB is based on REs, MCS and number of layers associated with each beam of beams to be transmitted by the plurality of UE antenna panels, or the TB with a maximum transport block size (TBS) of the TBs calculated for each beam/panel, or the TB with the minimum TBS of the TBs calculated for each beam/panel. In some embodiments, PUSCH mapping to resource elements is determined by assigned PRBs corresponding to each beam for its respective PUSCH of the plurality of PUSCHs.

In some embodiments, in a transmission scheme like SchemeC, the RRC configuration information comprises an uplink transmission scheme for transmitting multiple PUSCHs simultaneously using the plurality of the UE antenna panels comprises transmission of a plurality of TBs, then the uplink resource allocation specifies which TB of the plurality of TBs is associated with which PUCSCH of the plurality of PUSCHs, including indicating a MCS and number of layers for the TB. In some embodiments, the uplink resource allocation includes downlink control information (DCI) bitfields to specify one or more of MCS, NDI and RV associated with each codeword of the plurality of codewords. In some embodiments, the uplink resource allocation specifies slot-based repetitions with a redundancy version (RV) index for repetition occasions associated with each UE antenna panel for the plurality of PUSCHs.

In some embodiments, in a transmission scheme like SchemeC, the single TB calculation is based on calculations of separate TB calculations for each of the UE antenna panels according to 3GPP TS 38.214 Section 6.1.4.2 wherein n_{PRB} of each separate TB calculation for each UE antenna panel is a number of allocated PRBs associated with said each UE antenna panel and the code rate, modulation order and rank for said each separate TB calculation is obtained by an MCS and number of layers indicated for each separate TB calculation.

In response to the configuration information, processing logic configures the UE for transmitting multiple PUSCHs simultaneously using the plurality of the UE antenna panels (processing block 1403) and thereafter transmits the plurality of PUSCHs with the single TB without repetition, the single TB with repetition, or a plurality of TBs over the plurality of UE antenna panels, with each PUSCH of the plurality of PUSCHs being transmitted on a different UE antenna panel (processing block 1404).

In some embodiments, transmitting the plurality of PUSCHs resources, with each PUSCH of the plurality of PUSCHs being transmitted on a different UE antenna panel, is performed as part of transmitting multiple TBs using multiple slots using inter-slot frequency hopping.

In some embodiments, base station comprising a processor (or processing circuitry) configured to perform operations comprising: generating and sending an RRC configuration information, wherein the RRC configuration information comprises uplink transmission scheme using multiple antenna panels for transmitting multiple Physical Uplink Shared Channels (PUSCHs) simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability. In some embodiments, the base station also generates a single DCI that specifies an uplink resource allocation for a plurality of PUSCHs and transmits the single DCI to the UE.

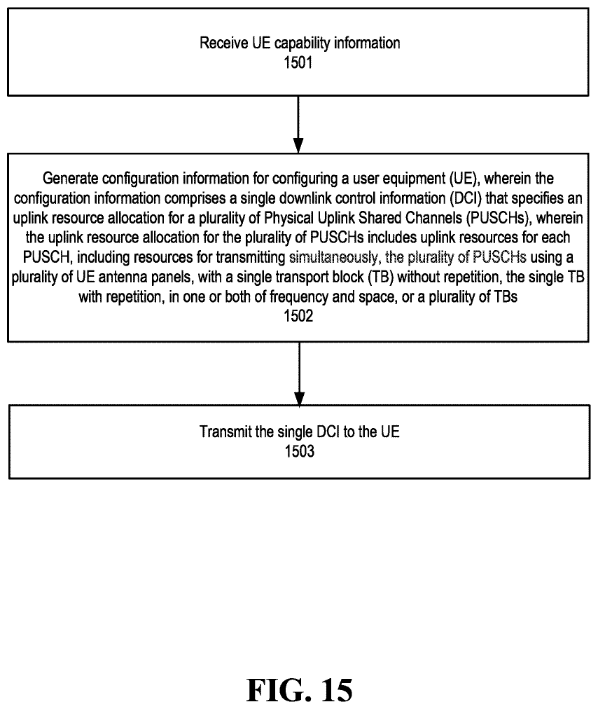

FIG. 15 is a flow diagram of one embodiment of a process by which network equipment configures a UE. The process is performed by processing logic that comprises hardware (circuitry, dedicated logic, etc.), software (e.g., software running on a chip, software run on a general-purpose computer system or a dedicated machine, etc.), firmware, or a combination of the three. In one embodiment, the operations in the process are performed by network equipment operating in a 5G new radio a spectrum in 5G new radio (NR) above 52.6 GHz. In some embodiments, the process is performed by a base station comprising a processor (or processing circuitry) configured to perform the following operations.

Referring to FIG. 15, the process begins by receiving UE capability information (processing block 1501). In some embodiments, the UE capability information is sent, via the UE, and received, by the base station, by Radio Resource Control (RRC) signaling or via dynamic signaling.

In some embodiments, in case where the UE is capable of using multiple transmission schemes such as those described herein (e.g., SchemeA, Scheme B, SchemeC, etc.), the base station may send the UE an indication specifying whether the uplink resource allocation is with resources for transmitting simultaneously, using a plurality of UE antenna panels, the single TB without repetition, the single TB with repetition, or a plurality of TBs. In some embodiments, the UE receives the indication through Radio Resource Control (RRC) signaling. In some embodiments, the UE may receive a dynamic DCI indication, from a base station, specifying whether the uplink resource allocation is with resources for transmitting simultaneously, using a plurality of UE antenna panels, the single TB without repetition, the single TB with repetition, or a plurality of TBs.

In some embodiments, the UE capability information specifies one or more of: a number of codewords per PUSCH transmission occasion, a number of code blocks per PUSCH transmission occasion, a number of transmission layers scheduled per a PUSCH transmission, a number of layers being transmitted when transmitting information on multiple PUSCHs simultaneously, a maximum modulation order, a transmission scheme. In some embodiments, the UE capability information specifies a combination a number of code blocks supported when a predetermined number of transmission layers are scheduled. In some embodiments, the UE capability information specifies a combination a number of code blocks per PUSCH transmission occasion when a predetermined number of transmission layers are scheduled.

Processing logic generates configuration information for configuring a user equipment (UE). In some embodiments, the configuration comprises RRC configuration information. The RRC configuration information can specify an uplink transmission scheme using multiple antenna panels for transmitting multiple Physical Uplink Shared Channels (PUSCHs) simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability

In some embodiments, processing logic also generates a single downlink control information (DCI) that specifies an uplink resource allocation for a plurality of Physical Uplink Shared Channels (PUSCHs), wherein the uplink resource allocation for the plurality of PUSCHs includes uplink resources for each PUSCH, including resources for transmitting simultaneously, the plurality of PUSCHs using a plurality of UE antenna panels, with a single transport block (TB) without repetition, the single TB with repetition, in one or both of frequency and space, or a plurality of TBs (processing block 1502). In some embodiments, the uplink resource allocation is based on a user equipment (UE) capability.

In some embodiments, if the RRC configuration information comprises an uplink transmission scheme for transmitting multiple PUSCHs simultaneously using the plurality of the UE antenna panels comprises transmission of a single TB without repetition (e.g., SchemeA), then the single TB is calculated across all frequency division multiplexing (FDM) and spatial division multiplexing (SDM) resources of the uplink resource allocation that are to be used for transmitting the single TB using the plurality of UE antenna panels and indicates a same Modulation Coding Scheme (MCS) and same number of layers for transmitting the single TB with the plurality of UE antenna panels. In some embodiments, the uplink resource allocation specifies slot-based repetitions with a redundancy version (RV) index per repetition occasion for the UE for beam hopping with the plurality of UE antenna panels across time domain repetitions. In some embodiments, if the RRC configuration information comprises an uplink transmission scheme for transmitting multiple PUSCHs simultaneously using the plurality of the UE antenna panels comprises transmission of the single TB without repetition (e.g., SchemeA), then the single TB is calculated across all frequency division multiplexing (FDM) and spatial division multiplexing (SDM) resources of the uplink resource allocation that are to be used for transmitting the single TB using the plurality of UE antenna panels and indicates a Modulation Coding Scheme (MCS) and number of layers for each UE antenna panel for transmitting the single TB with the plurality of UE antenna panels.

In some embodiments, in a transmission scheme like SchemeA, when a single MCS bit-field and number of layers is applied to the plurality of UE antenna panels, the single TB is calculated according to 3GPP TS 38.214 Section 6.1.4.2 using a total number of allocated PRBs across all of the plurality of UE antenna panels. In some embodiments, when the MCS and number of layers is separately indicated for each UE antenna panel of the plurality of UE antenna panels, the single TB calculation is based on separate TB calculations for each of the UE antenna panels according to 3GPP TS 38.214 Section 6.1.4.2 using a number of allocated PRBs associated with each of the plurality of UE antenna panels. In some embodiments, in a transmission scheme like SchemeA, PUSCH mapping to resource elements is determined by assigned PRBs corresponding to each beam for its respective PUSCH of the plurality of PUSCHs.

In some embodiments, in a transmission scheme like SchemeA, transmitting the plurality of PUSCHs, with each PUSCH of the plurality of PUSCHs being transmitted on a different UE antenna panel, is performed as part of transmitting multiple TBs using multiple slots using inter-slot frequency hopping.

In some embodiments, in a transmission scheme like SchemeB, if the RRC configuration information comprises an uplink transmission scheme for transmitting multiple PUSCHs simultaneously using the plurality of the UE antenna panels comprises transmission of the single TB with repetition, then the single TB is transmitted with repetition in one or both of frequency and space. In some embodiments, in a transmission scheme like SchemeB, if the RRC configuration information comprises an uplink transmission scheme for transmitting multiple PUSCHs simultaneously using the plurality of the UE antenna panels comprises transmission of the single TB with repetition, then the uplink resource allocation specifies the same resources, MCS and a number of layers for the single TB for each PUSCH per beam, with a different code rate per repetition. In some embodiments, the uplink resource allocation specifies slot-based repetitions with a redundancy version (RV) index for repetitions for each PUSCH of the plurality of PUSCHs without time domain repetitions. In some embodiments, the uplink resource allocation specifies slot-based repetitions with a redundancy version (RV) index per repetition occasion for the UE for beam hopping with the plurality of UE antenna panels across time domain repetitions, with a first RV for PUSCH repetitions associated with a first UE antenna panel being based on a count of PUSCH transmission occasions associated with the first UE antenna panel and a second RV associated with a second UE antenna panel being based on the first RV and an offset.

In some embodiments, in a transmission scheme like SchemeB, the calculation of the TB is based on resources, MCS and number of layers associated with each beam of beams to be transmitted by the plurality of UE antenna panels, or the TB with a maximum transport block size (TBS) of the TBs calculated for each beam/panel, or the TB with the minimum TBS of the TBs calculated for each beam/panel. In some embodiments, PUSCH mapping to resource elements is determined by assigned PRBs corresponding to each beam for its respective PUSCH of the plurality of PUSCHs.

In some embodiments, in a transmission scheme like SchemeC, if the RRC configuration information comprises an uplink transmission scheme for transmitting multiple PUSCHs simultaneously using the plurality of the UE antenna panels comprises transmission of a plurality of transport blocks (TBs), then the uplink resource allocation which TB of the plurality of TBs is associated with which PUCSCH of the plurality of PUSCHs, including indicating a MCS and number of layers for the TB. In some embodiments, the uplink resource allocation includes downlink control information (DCI) bitfields to specify one or more of MCS, NDI and RV associated with each codeword of the plurality of codewords. In some embodiments, the uplink resource allocation specifies slot-based repetitions with a redundancy version (RV) index for repetition occasions associated with each UE antenna panel for the plurality of PUSCHs.

In some embodiments, in a transmission scheme like SchemeC, the single TB calculation is based on calculations of separate TB calculations for each of the UE antenna panels according to 3GPP TS 38.214 Section 6.1.4.2 wherein n_{PRB} of each separate TB calculation for each UE antenna panel is a number of allocated PRBs associated with said each UE antenna panel and the code rate, modulation order and rank for said each separate TB calculation is obtained by an MCS and number of layers indicated for each separate TB calculation.

After generation the single DCI, processing logic transmits the single DCI to the UE (processing block 1503).

There are a number of example embodiments described herein.

Example 1 is a method that may be performed by a baseband processor or UE, where the method includes receiving an RRC configuration information from a base station, wherein the RRC configuration information comprises an uplink transmission scheme using multiple antenna panels for transmitting multiple PUSCHs simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability; receiving a single downlink control information (DCI) that specifies an uplink resource allocation for a plurality of Physical Uplink Shared Channels (PUSCHs); and transmitting the plurality of PUSCHs.

Example 2 is the method of example 1 that may optionally include that, if the RRC configuration information comprises an uplink transmission scheme for transmitting multiple PUSCHs simultaneously using the plurality of the UE antenna panels comprises transmission of the single transport block (TB) without repetition, then the single DCI indicates resources for calculating the single TB across all frequency division multiplexing (FDM) and spatial division multiplexing (SDM) resources of the uplink resource allocation that are to be used for transmitting the single TB using the plurality of UE antenna panels, including an indication of a same Modulation Coding Scheme (MCS) and same number of layers for the single TB.

Example 3 is the method of example 2 that may optionally include that the uplink resource allocation specifies slot-based repetitions with a redundancy version (RV) index per repetition occasion for the UE for beam hopping with the plurality of UE antenna panels across time domain repetitions.

Example 4 is the method of example 2 that may optionally include that, if the RRC configuration information comprises an uplink transmission scheme for transmitting multiple PUSCHs simultaneously using the plurality of the UE antenna panels comprises transmission of the single transport block (TB) without repetition, then the single DCI indicates resources for calculating the single TB across all frequency division multiplexing (FDM) and spatial division multiplexing (SDM) resources of the uplink resource allocation that are to be used for transmitting the single TB using the plurality of UE antenna panels, including an indication of a Modulation Coding Scheme (MCS) and number of layers for each UE antenna panel for the single TB.

Example 5 is the method of example 1 or 2 that may optionally include that, when a single MCS bit-field and number of layers is applied to the plurality of UE antenna panels, the single TB is calculated using a total number of allocated PRBs across all of the plurality of UE antenna panels.

Example 6 is the method of example 2 that may optionally include that, when the MCS and number of layers is separately indicated for each UE antenna panel of the plurality of UE antenna panels, the single TB calculation is based on separate TB calculations for each of the UE antenna panels using a number of allocated PRBs associated with each of the plurality of UE antenna panels.

Example 7 is the method of example 2 that may optionally include that PUSCH mapping to resource elements is determined by assigned PRBs corresponding to each beam for its respective PUSCH of the plurality of PUSCHs.

Example 8 is the method of example 2 that may optionally include that transmitting information on the plurality of PUSCHs resources, with each PUSCH of the plurality of PUSCHs being transmitted on a different UE antenna panel, is performed as part of transmitting multiple TBs using multiple slots using inter-slot frequency hopping.

Example 9 is the method of example 1 that may optionally include that, if the RRC configuration information comprises an uplink transmission scheme for transmitting multiple PUSCHs simultaneously using the plurality of the UE antenna panels comprises transmission of the single TB, then the single TB is transmitted with repetition in one or both of frequency and space.

Example 10 is the method of example 9 that may optionally include that, if the RRC configuration information comprises an uplink transmission scheme for transmitting multiple PUSCHs simultaneously using the plurality of the UE antenna panels comprises transmission of the single TB with repetition, wherein the uplink resource allocation specifies the same resources, MCS and a number of layers for the single TB for each PUSCH per beam, with a different code rate per repetition.

Example 11 is the method of example 10 that may optionally include that the uplink resource allocation specifies slot-based repetitions with a redundancy version (RV) index for repetitions for each PUSCH of the plurality of PUSCHs without time domain repetitions.

Example 12 is the method of example 10 that may optionally include that the uplink resource allocation specifies slot-based repetitions with a redundancy version (RV) index per repetition occasion for the UE for beam hopping with the plurality of UE antenna panels across time domain repetitions, with a first RV for PUSCH repetitions associated with a first UE antenna panel being based on a count of PUSCH transmission occasions associated with the first UE antenna panel and a second RV associated with a second UE antenna panel being based on the first RV and an offset.

Example 13 is the method of example 1 or 9 that may optionally include that the single DCI indicates that calculation of the TB is based on REs, MCS and number of layers associated with each beam of beams to be transmitted by the plurality of UE antenna panels or the TB with a maximum transport block size (TBS) of the TBs calculated for each UE antenna panel, or the TB with the minimum TBS of the TBs calculated for each UE antenna panel. Example 14 is the method of example 9 that may optionally include that PUSCH mapping to resource elements is determined by assigned PRBs corresponding to each beam for its respective PUSCH of the plurality of PUSCHs.

Example 15 is the method of example 1 that may optionally include that, if the RRC configuration information comprises an uplink transmission scheme for transmitting multiple PUSCHs simultaneously using the plurality of the UE antenna panels comprises transmission of the plurality of TBs, then the uplink resource allocation indicates which TB of the plurality of TBs is associated with which PUSCH of the plurality of PUSCHs, including indicating a MCS and number of layers for the TB.

Example 16 is the method of example 15 that may optionally include that the uplink resource allocation includes downlink control information (DCI) bitfields to specify one or more of MCS, NDI and RV associated with each codeword of the plurality of codewords.

Example 17 is the method of example 15 that may optionally include that the uplink resource allocation specifies slot-based repetitions with a redundancy version (RV) index for repetition occasions associated with each UE antenna panel for the plurality of PUSCHs.

Example 18 is the method of example 1 or 15 that may optionally include that the single TB calculation is based on calculations of separate TB calculations for each of the UE antenna panels wherein n_{PRB} of separately calculating each TB for each UE antenna panel is a number of allocated PRBs associated with said each UE antenna panel and the code rate, modulation order and rank for calculating said each TB is obtained by an MCS and number of layers for said each separately TB calculation.

Example 19 is the method of example 1 that may optionally include that the RRC configuration information comprises an uplink transmission scheme that specifies a plurality of transmission schemes, and further wherein the single DCI includes an indication of one of the plurality of transmission schemes.

Example 20 is the method of example 1 that may optionally include that transmitting information on the plurality of PUSCHs resources, with each PUSCH of the plurality of PUSCHs being transmitted on a different UE antenna panel, is performed as part of transmitting multiple TBs using multiple slots using inter-slot frequency hopping.

Example 21 is a baseband processor configured to perform any one of the operations set forth in examples 1-20.

Example 22 is a UE configured to perform any one of the operations set forth in examples 1-20.

Example 23 is one or more non-transitory computer readable storage media having instructions stored thereupon which, when executed by a UE or baseband processor causes any one of the operations set forth in examples 1-20 to be performed.

Example 24 is a method performed by base station comprising a processor (or processing circuitry) configured to perform operations comprising: sending an RRC configuration information, wherein the RRC configuration information comprises an uplink transmission scheme using multiple antenna panels for transmitting multiple PUSCHs simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability; sending a single downlink control information (DCI) that specifies an uplink resource allocation for a plurality of Physical Uplink Shared Channels (PUSCHs); and transmitting the single DCI to the UE.

Example 25 is the method of example 24 that may optionally include that, if the RRC configuration information comprises an uplink transmission scheme for transmitting multiple PUSCHs simultaneously using the plurality of the UE antenna panels comprises transmission of the single TB without repetition, then the single DCI indicates resources for calculating the single TB across all frequency division multiplexing (FDM) and spatial division multiplexing (SDM) resources of the uplink resource allocation that are to be used for transmitting the single TB using the plurality of UE antenna panels, including an indication of a same Modulation Coding Scheme (MCS) and same number of layers for the single TB.

Example 26 is the method of example 25 that may optionally include that the uplink resource allocation specifies slot-based repetitions with a redundancy version (RV) index per repetition occasion for the UE for beam hopping with the plurality of UE antenna panels across time domain repetitions.

Example 27 is the method of example 25 that may optionally include that, if the RRC configuration information comprises an uplink transmission scheme for transmitting multiple PUSCHs simultaneously using the plurality of the UE antenna panels comprises transmission of the single TB without repetition, then the single DCI indicates resources for calculating the single TB across all frequency division multiplexing (FDM) and spatial division multiplexing (SDM) resources of the uplink resource allocation that are to be used for transmitting the single TB using the plurality of UE antenna panels, including an indication of a Modulation Coding Scheme (MCS) and number of layers for each UE antenna panel for the single TB.

Example 28 is the method of example 24 or 25 that may optionally include that, when a single MCS bit-field and number of layers is applied to the plurality of UE antenna panels, the single TB is calculated using a total number of allocated PRBs across all of the plurality of UE antenna panels.

Example 29 is the method of example 26 that may optionally include that, when the MCS and number of layers is separately indicated for each UE antenna panel of the plurality of UE antenna panels, the single TB calculation is based on separate TB calculations for each of the UE antenna panels using a number of allocated PRBs associated with each of the plurality of UE antenna panels.

Example 30 is the method of example 24 that may optionally include that PUSCH mapping to resource elements is determined by assigned PRBs corresponding to each beam for its respective PUSCH of the plurality of PUSCHs.

Example 31 is the method of example 25 that may optionally include that wherein transmitting information on the plurality of PUSCHs resources, with each PUSCH of the plurality of PUSCHs being transmitted on a different UE antenna panel, is performed as part of transmitting multiple TBs using multiple slots using inter-slot frequency hopping.

Example 32 is the method of example 24 that may optionally include that, if the RRC configuration information comprises an uplink transmission scheme for transmitting multiple PUSCHs simultaneously using the plurality of the UE antenna panels comprises transmission of the single TB, then the single TB is transmitted with repetition in one or both of frequency and space.

Example 33 is the method of example 32 that may optionally include that, if the RRC configuration information comprises an uplink transmission scheme for transmitting multiple PUSCHs simultaneously using the plurality of the UE antenna panels comprises transmission of the single transport block (TB) with repetition, then the uplink resource allocation specifies the same resources, MCS and a number of layers for the single TB for each PUSCH per beam, with a different code rate per repetition.

Example 34 is the method of example 33 that may optionally include that the uplink resource allocation specifies slot-based repetitions with a redundancy version (RV) index for repetitions for each PUSCH of the plurality of PUSCHs without time domain repetitions.

Example 35 is the method of example 33 that may optionally include that the uplink resource allocation specifies slot-based repetitions with a redundancy version (RV) index per repetition occasion for the UE for beam hopping with the plurality of UE antenna panels across time domain repetitions, with a first RV for PUSCH repetitions associated with a first UE antenna panel being based on a count of PUSCH transmission occasions associated with the first UE antenna panel and a second RV associated with a second UE antenna panel being based on the first RV and an offset.

Example 36 is the method of example 24 or 32 that may optionally include that calculation of the TB is based on REs, MCS and number of layers associated with each beam of beams to be transmitted by the plurality of UE antenna panels, the TB with a maximum transport block size (TBS) of the TBs calculated for each UE antenna panel, or the TB with the minimum TBS of the TBs calculated for each UE antenna panel.

Example 37 is the method of example 32 that may optionally include that PUSCH mapping to resource elements is determined by assigned PRBs corresponding to each beam for its respective PUSCH of the plurality of PUSCHs.

Example 38 is the method of example 24 that may optionally include that, if the RRC configuration information comprises an uplink transmission scheme for transmitting multiple PUSCHs simultaneously using the plurality of the UE antenna panels comprises transmission of the plurality of TBs, then the uplink resource allocation indicates which TB of the plurality of TBs is associated with which PUSCH of the plurality of PUSCHs, including indicating a MCS and number of layers for the TB.

Example 39 is the method of example 38 that may optionally include that the uplink resource allocation includes downlink control information (DCI) bitfields to specify one or more of MCS, NDI and RV associated with each codeword of the plurality of codewords.

Example 40 is the method of example 38 that may optionally include that the uplink resource allocation specifies slot-based repetitions with a redundancy version (RV) index for repetition occasions associated with each UE antenna panel for the plurality of PUSCHs.

Example 41 is the method of example 24 or 38 that may optionally include that the single TB calculation is based on calculations of separate TB calculations for each of the UE antenna panels wherein n_{PRB} of each separate TB calculation for each UE antenna panel is a number of allocated PRBs associated with said each UE antenna panel and the code rate, modulation order and rank for said each separate TB calculation is obtained by an MCS and number of layers for said each separate TB calculation.

Example 42 is the method of example 24 that may optionally include that the RRC configuration information comprises an uplink transmission scheme that specifies a plurality of transmission schemes, and further wherein the single DCI includes an indication of one of the plurality of transmission schemes.

Example 43 is a baseband processor of a base station configured to perform any one of the operations set forth in examples 24-42.

Example 44 is a base station configured to perform any one of the operations set forth in examples 24-42.

Example 45 is one or more non-transitory computer readable storage media of a base station having instructions stored thereupon which, when executed by a UE or baseband processor causes any one of the operations set forth in examples 24-42 to be performed.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present invention. One skilled in the art will readily recognize from such discussion, the accompanying drawings and the claims that various modifications can be made without departing from the spirit and scope of the invention.

1. A baseband processor configured to perform operations comprising:
receiving an RRC configuration information from a base station, wherein the RRC configuration information comprises an uplink transmission scheme using multiple antenna panels for transmitting multiple Physical Uplink Shared Channels (PUSCHs) simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability;
receiving a single downlink control information (DCI) that specifies an uplink resource allocation for a plurality of PUSCHs; and
transmitting the plurality of PUSCHs.

2. The baseband processor of claim 1, wherein, if the RRC configuration information comprises an uplink transmission scheme for transmitting multiple PUSCHs simultaneously using the plurality of the UE antenna panels comprises transmission of the single transport block (TB) without repetition, then the single DCI indicates resources for calculating the single TB across all frequency division multiplexing (FDM) and spatial division multiplexing (SDM) resources of the uplink resource allocation that are to be used for transmitting the single TB using the plurality of UE antenna panels, including an indication of a same Modulation Coding Scheme (MCS) and same number of layers for the single TB.

3. The baseband processor of claim 1 wherein, when a single MCS bit-field and number of layers is applied to the plurality of UE antenna panels, the single TB is calculated using a total number of allocated PRBs across all of the plurality of UE antenna panels, and wherein PUSCH mapping to resource elements is determined by assigned PRBs corresponding to each beam for its respective PUSCH of the plurality of PUSCHs.

4. The baseband processor of claim 1, wherein, if the RRC configuration information comprises an uplink transmission scheme for transmitting multiple PUSCHs simultaneously using the plurality of the UE antenna panels comprises transmission of the single TB, then the single transport block TB is transmitted with repetition in one or both of frequency and space, and wherein, if the uplink resource allocation includes resources for transmitting simultaneously, using a plurality of UE antenna panels, the single transport block (TB) with repetition, wherein the uplink resource allocation specifies the same resources, MCS and a number of layers for the single TB for each PUSCH per beam, with a different code rate per repetition.

5. The baseband processor of claim 10, wherein the uplink resource allocation specifies slot-based repetitions with a redundancy version (RV) index for repetitions for each PUSCH of the plurality of PUSCHs without time domain repetitions or per repetition occasion for the UE for beam hopping with the plurality of UE antenna panels across time domain repetitions, with a first RV for PUSCH repetitions associated with a first UE antenna panel being based on a count of PUSCH transmission occasions associated with the first UE antenna panel and a second RV associated with a second UE antenna panel being based on the first RV and an offset.

6. The baseband processor of claim 1, wherein the single DCI indicates that calculation of the TB is based on REs, MCS and number of layers associated with each beam of beams to be transmitted by the plurality of UE antenna panels or the TB with a maximum transport block size (TBS) of the TBs calculated for each UE antenna panel, or the TB with the minimum TBS of the TBs calculated for each UE antenna panel.

7. The baseband processor of claim 4, wherein PUSCH mapping to resource elements is determined by assigned PRBs corresponding to each beam for its respective PUSCH of the plurality of PUSCHs.

8. The baseband processor of claim 1, wherein, if the RRC configuration information comprises an uplink transmission scheme for transmitting multiple PUSCHs simultaneously using the plurality of the UE antenna panels comprises transmission of the plurality of transport blocks (TBs), then the uplink resource allocation indicates which TB of the plurality of TBs is associated with which PUSCH of the plurality of PUSCHs, including indicating a MCS and number of layers for the TB.

9. The baseband processor of claim 8 wherein the uplink resource allocation includes downlink control information (DCI) bitfields to specify one or more of MCS, NDI and RV associated with each codeword of the plurality of codewords.

10. The baseband processor of claim 8, wherein the uplink resource allocation specifies slot-based repetitions with a redundancy version (RV) index for repetition occasions associated with each UE antenna panel for the plurality of PUSCHs.

11. The baseband processor of claim 1 wherein the single TB calculation is based on calculations of separate TB calculations for each of the UE antenna panels wherein n_{PRB} of separately calculating each TB for each UE antenna panel is a number of allocated PRBs associated with said each UE antenna panel and the code rate, modulation order and rank for calculating said each TB is obtained by an MCS and number of layers for said each separately TB calculation.

12. The baseband processor of claim 1 wherein the RRC configuration information comprises an uplink transmission scheme that specifies a plurality of transmission schemes, and further wherein the single DCI includes an indication of one of the plurality of transmission schemes.

13. The baseband processor of claim 1 wherein transmitting information on the plurality of PUSCHs resources, with each PUSCH of the plurality of PUSCHs being transmitted on a different UE antenna panel, is performed as part of transmitting multiple TBs using multiple slots using inter-slot frequency hopping.

14. A method performed by a UE, the method comprising:
receiving an RRC configuration information from a base station, wherein the RRC configuration information comprises an uplink transmission scheme using multiple antenna panels for transmitting multiple PUSCHs simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability;
receiving a single downlink control information (DCI) that specifies an uplink resource allocation for a plurality of Physical Uplink Shared Channels (PUSCHs); and
transmitting the plurality of PUSCHs.

15. The method of claim 14 wherein, if the RRC configuration information comprises an uplink transmission scheme for transmitting multiple PUSCHs simultaneously using the plurality of the UE antenna panels comprises transmission of the plurality of transport blocks (TBs), then the uplink resource allocation indicates which TB of the plurality of TBs is associated with which PUSCH of the plurality of PUSCHs, including indicating a MCS and number of layers for the TB.

16. The method of claim 14 wherein the single TB calculation is based on calculations of separate TB calculations for each of the UE antenna panels according to 3GPP TS 38.214 Section 6.1.4.2 wherein n_{PRB} of separately calculating each TB for each UE antenna panel is a number of allocated PRBs associated with said each UE antenna panel and the code rate, modulation order and rank for calculating said each TB is obtained by an MCS and number of layers for said each separately TB calculation.

17. The method of claim 14 wherein, when a single MCS bit-field and number of layers is applied to the plurality of UE antenna panels, the single TB is calculated according to 3GPP TS 38.214 Section 6.1.4.2 using a total number of allocated PRBs across all of the plurality of UE antenna panels, and wherein PUSCH mapping to resource elements is determined by assigned PRBs corresponding to each beam for its respective PUSCH of the plurality of PUSCHs.

18. A base station comprising a processor (or processing circuitry) configured to perform operations comprising:
sending an RRC configuration information, wherein the RRC configuration information comprises an uplink transmission scheme using multiple antenna panels for transmitting multiple Physical Uplink Shared Channels (PUSCHs) simultaneously using the plurality of the UE antenna panels, wherein the uplink transmission scheme using multiple antenna panels comprises transmission of a single transport block (TB) without repetition, transmission of a single TB with repetition, or transmission of a plurality of TBs, based on a user equipment (UE) capability;
generating a single downlink control information (DCI) that specifies an uplink resource allocation for a plurality of PUSCHs; and
transmitting the single DCI to the UE.

19. The base station of claim 18, wherein, if the RRC configuration information comprises an uplink transmission scheme for transmitting multiple PUSCHs simultaneously using the plurality of the UE antenna panels comprises transmission of the plurality of transport blocks (TBs), then the uplink resource allocation indicates which TB of the plurality of TBs is associated with which PUSCH of the plurality of PUSCHs, including indicating a MCS and number of layers for the TB, and wherein the uplink resource allocation includes downlink control information (DCI) bitfields to specify one or more of MCS, NDI and RV associated with each codeword of the plurality of codewords.

20. The base station of claim 18 wherein the single TB calculation is based on calculations of separate TB calculations for each of the UE antenna panels according to 3GPP TS 38.214 Section 6.1.4.2 wherein n_{PRB} of separately calculating each TB for each UE antenna panel is a number of allocated PRBs associated with said each UE antenna panel and the code rate, modulation order and rank for calculating said each TB is obtained by an MCS and number of layers for said each separately TB calculation.
